(19) United States
(12) Patent Application Publication
(10) Pub. No.: US 2009/0164606 A1
(43) Pub. Date: Jun. 25, 2009

(54) WEB UPLOADS

(75) Inventors: Eustachio Epifania, Nivaa (DK); Eduardo Pretel, Frederiksberg (DK); Carl Clausen, Kokkedal (DK); Mark Fowlie, Copenhagen N (DK); Steen Hagelund, Copenhagen OE (DK); Mikkel Joergensen, Lyngby (DK); Harri Tunturivuori, Malmoe (SE); Jesper Majland, Greve (DK); Morten Keldebaek, Smoerum (DK); Peter Wass-Denielsen, Hellerup (DK)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/962,378

(22) Filed: Dec. 21, 2007

(51) Int. Cl. G06F 15/16

(52) U.S. Cl. 709/219

(57) ABSTRACT

The disclosed embodiments relate to a method and apparatus that includes accessing at least one content item stored in a device, selecting a remote server to which to transfer the at least one content item, and transferring the at least one content item to the remote server.

### BACKGROUND

1. Field

The disclosed embodiments generally relate to user interfaces and, more particularly, to uploading and transferring media content.

2. Brief Description of Related Developments

Devices, such as mobile communication devices, are often used to store media content, such as images and videos. Many mobile phones include cameras. When pictures are taken, they are typically stored in memory in the device. The user can later transfer to the images to an external storage device for processing.

With the advent of digital imaging, there are a number of on-line or web services that allow users to upload multimedia content for storing and sharing. Users can upload their images to these web services where the images are stored in the user's account, and the images can be accessed by those who have access to the account. This allows for “on-line” sharing of images and other media content.

It would be advantageous to be able to send images from a mobile communication device to a web service for image storage and processing.

It would also be advantageous to be able to access a web uploading service and upload multimedia images from a mobile communication device.

### SUMMARY

The aspects of the disclosed embodiments relate to at least a method, and an apparatus and computer program for carrying out aspects of the method, where the method includes accessing at least one content item stored in a device, selecting a remote server to which to transfer the at least one content item, and transferring the at least one content item to the remote server. Further aspects of the disclosed embodiments are described in the claims.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIGS. 2A1-2A2 are illustrations of exemplary screen shots of a user interface in accordance with the disclosed embodiments;

FIGS. 3B1-3B14 are illustrations of exemplary screen shots of a user interface and process flow in accordance with the disclosed embodiments;

FIGS. 4C1-4C26 are illustrations of process flow using exemplary screen shots of a user interface in accordance with the disclosed embodiments;

FIGS. 5A and 5B are illustrations of examples of devices that can be used to practice aspects of the disclosed embodiments;

FIG. 6 illustrates a block diagram of an exemplary system incorporating features that may be used to practice aspects of the disclosed embodiments; and

FIG. 7 is a block diagram illustrating the general architecture of an exemplary system in which the exemplary devices of FIGS. 6A and 6B may be used.

### DETAILED DESCRIPTION OF THE EMBODIMENT(S)

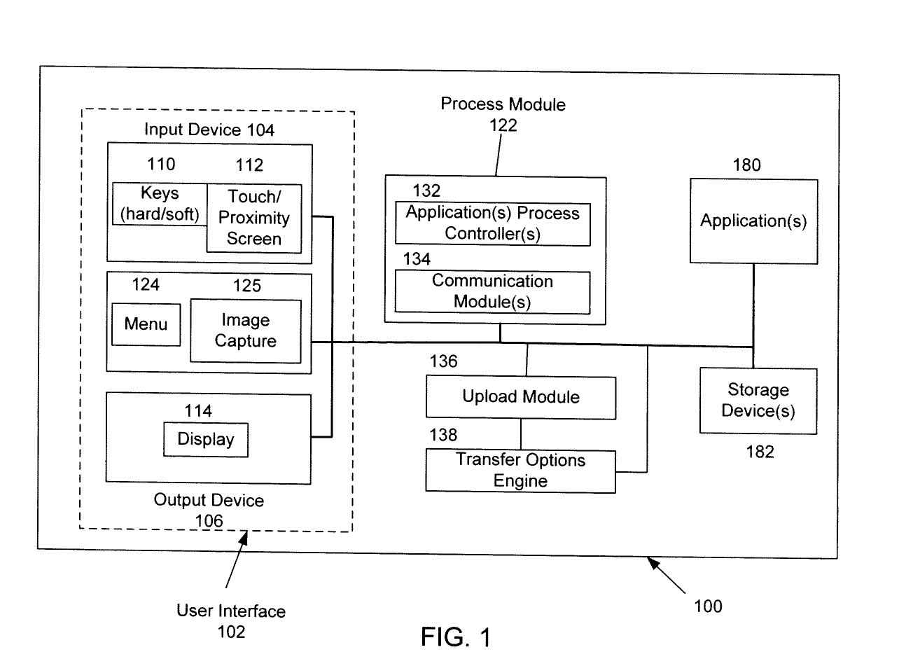

FIG. 1 illustrates one embodiment of a system 100 in which aspects of the disclosed embodiments can be used. Although aspects of the disclosed embodiments will be described with reference to the embodiments shown in the drawings and described below, it should be understood that these aspects could be embodied in many alternate forms. In addition, any suitable size, shape or type of elements or materials could be used.

The disclosed embodiments generally allow a user of a device or system, such as the system 100 shown in FIG. 1, to quickly and easily transfer or upload media content from the device to a web service for storing and sharing media content. For example, a person takes photos using a camera on a mobile phone. It is desirable to have a quick and simple way to upload the photos to an online image center, such as for example, a Window Live Spaces™ account, so that the person can easily share the photos with others over the web and preserve storage space in the device.

In one embodiment, a user can take a picture with a mobile device and upload the picture to an online folder for storing and sharing, with a few simple steps. Alternatively, the user can access images stored in the device and transfer them to the online folder or up-load service in a similar fashion. The device is able to store web service addresses and settings, such as for example the user name and password, for more than one account. This will enable ease of access and upload from the device. Sending or transferring the images or files should be similar to the process used for messaging on a mobile communication device.

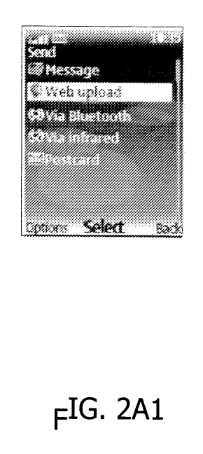

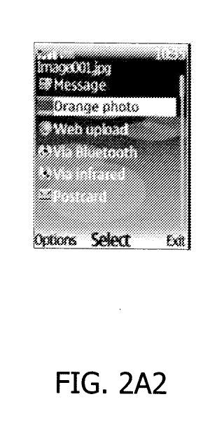

FIG. 2A1 illustrates one example of a “SEND” options menu on a user interface of a device incorporating aspects of the disclosed embodiments. As shown in FIG. 2A1, the SEND menu A101 has been selected from an OPTIONS menu screen (not shown). As will be understood, when messaging, the user is able to select one or more options to create and send a message from the device. The options menu and the send menu A101 can be selected by the user in any suitable or device specific fashion. A send menu A101 will generally provide the user with one or more technologies or services by which to transfer or send content, such as a message or file. As shown in FIG. 2A1, some of these send options can include for example, “Message”, “Via Bluetooth”, “Via infrared” or “Postcard” A102. The list shown in FIG. 2A1 is exemplary and is not intended to be exhaustive, as other methodologies and technologies may be equally applicable and useable.

As shown in FIG. 2A1, the send menu A101 of the disclosed embodiments includes a “web upload” A103 selection feature or option. This option availability allows a user the ability to enable a web upload function of the device. Once the user has selected an image for transfer, the user can navigate to the Send options menu A101 and select an appropriate technology or method option for the transfer, such as the Web Upload A103.

FIG. 2A2 illustrates an example of a Send options menu A202 that includes a specific service menu selection item that can be selected to transfer the image(s). In the example of FIG. A2, an image has been selected to be transferred as illustrated by the display of the file object Image001.jpg A202. The user navigates to the Send menu A201. On this Send menu, a number of send or transfer options A203-A206 are presented to the user. In this example, the menu A201 includes a specific service provider or carrier option, shown as Orange™ photo A206. This option can allow specific carrier(s) to be more visible in the Send menu A201. The user highlights or selects the carrier option A206 in a suitable fashion and then activates the Select option A207 to access the selected carrier option A206 in a manner that will be understood by one of skill in the art. Although this example shows only one such carrier, it will be understood that in alternate embodiments and suitable number and type of such carrier can be included. When the user selects the send option A206, the particular service can automatically be accessed by the device and the image001.jpg A202 uploaded to the service according to the particular service requirements. In one embodiment, the device will store all access, security and login settings, such as a user name and password, which will allow the device to automatically access and log-in to the user's account with the desired service. In alternate embodiments, any desired access and security settings can be established and stored to enable secure access and transfer of the desired image(s) to the particular service.

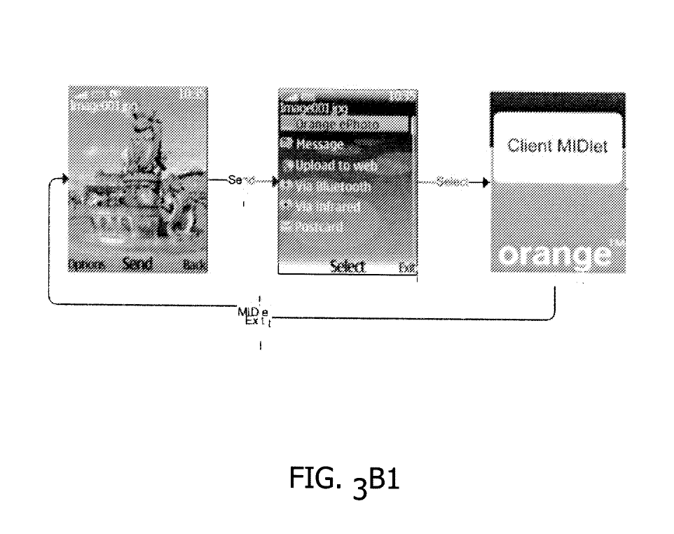

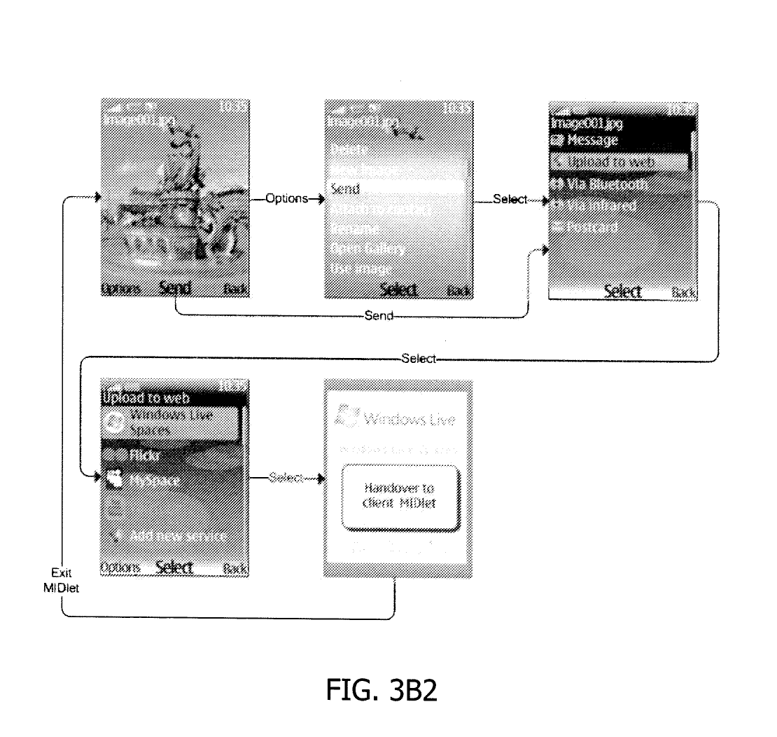

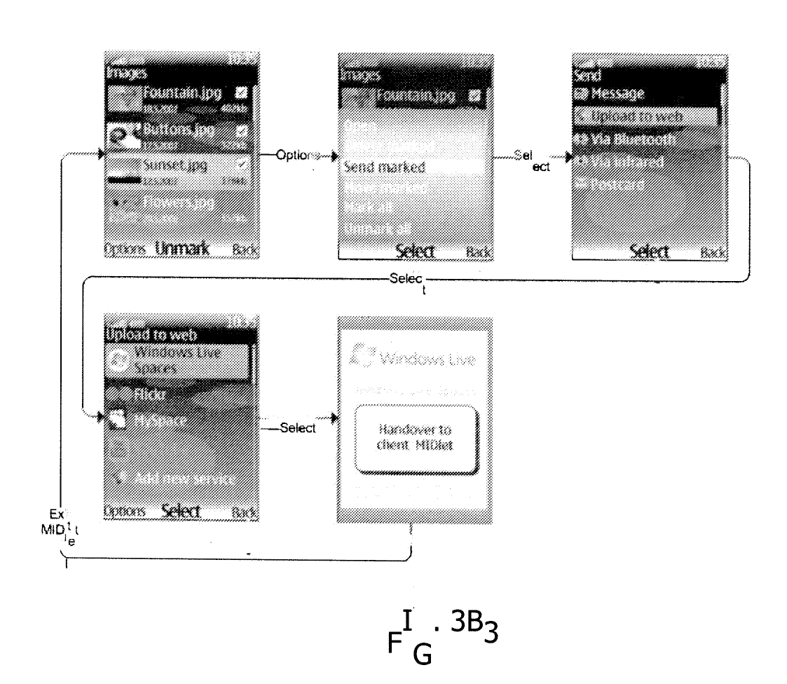

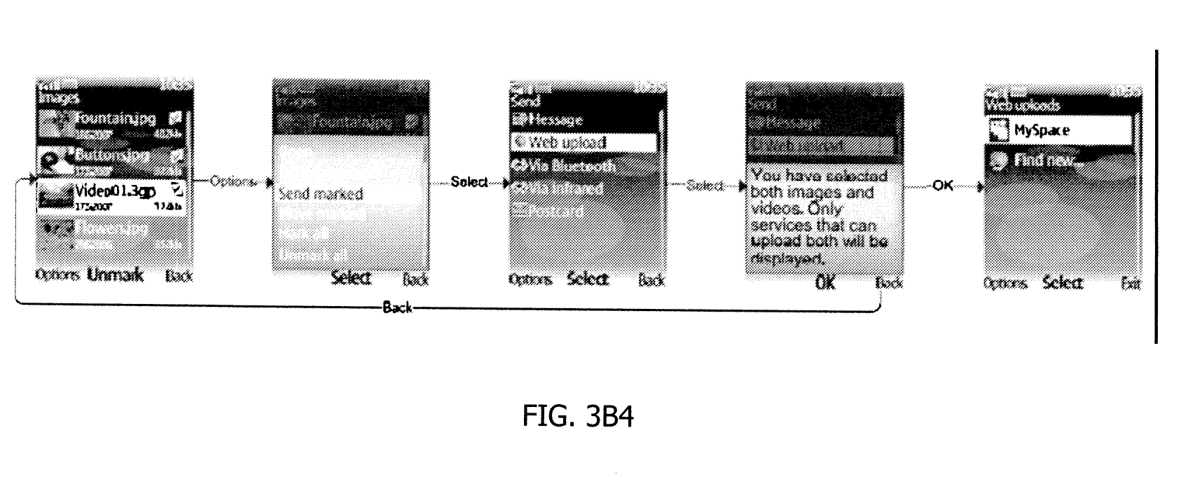

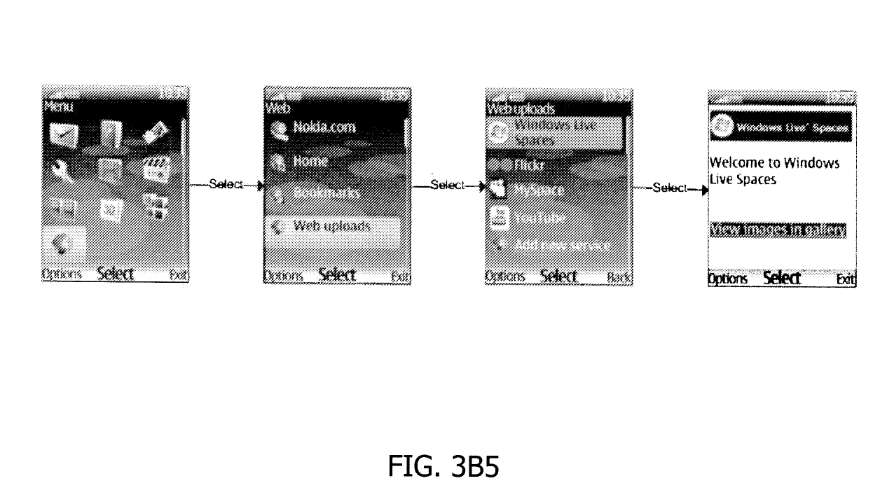

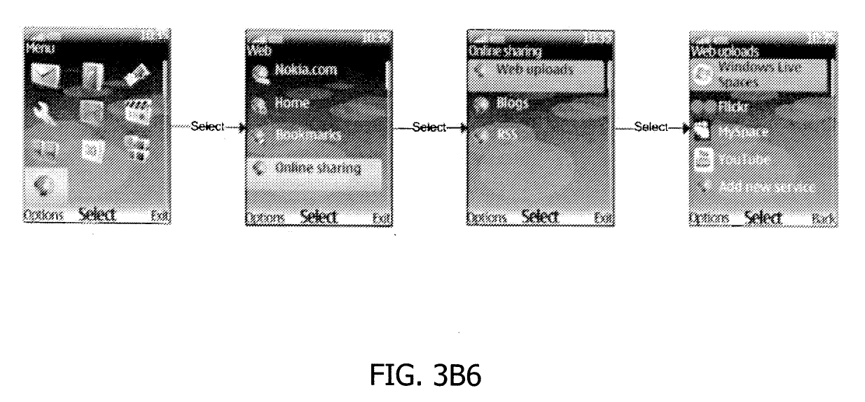

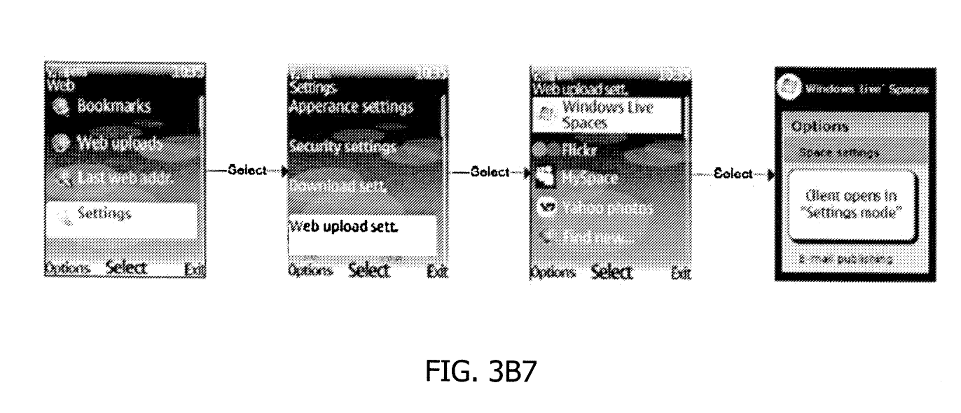

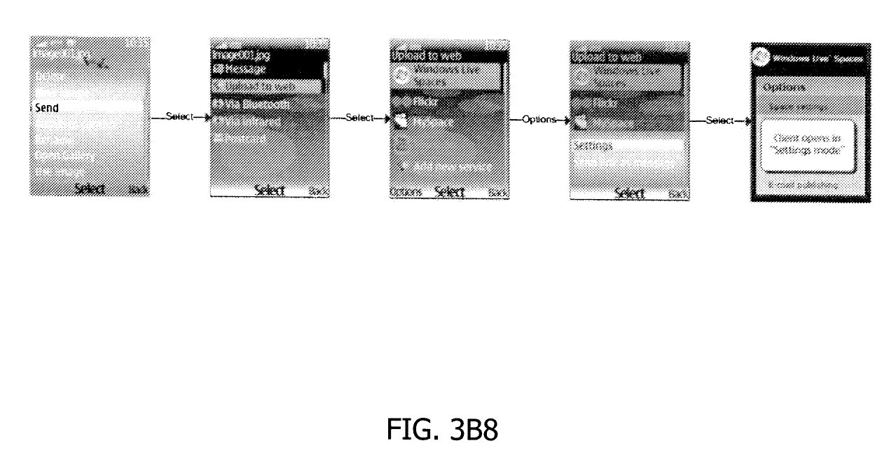

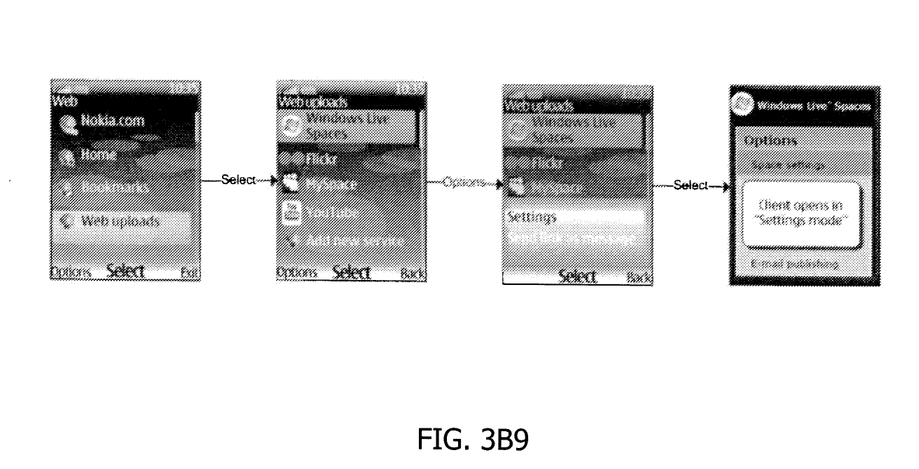

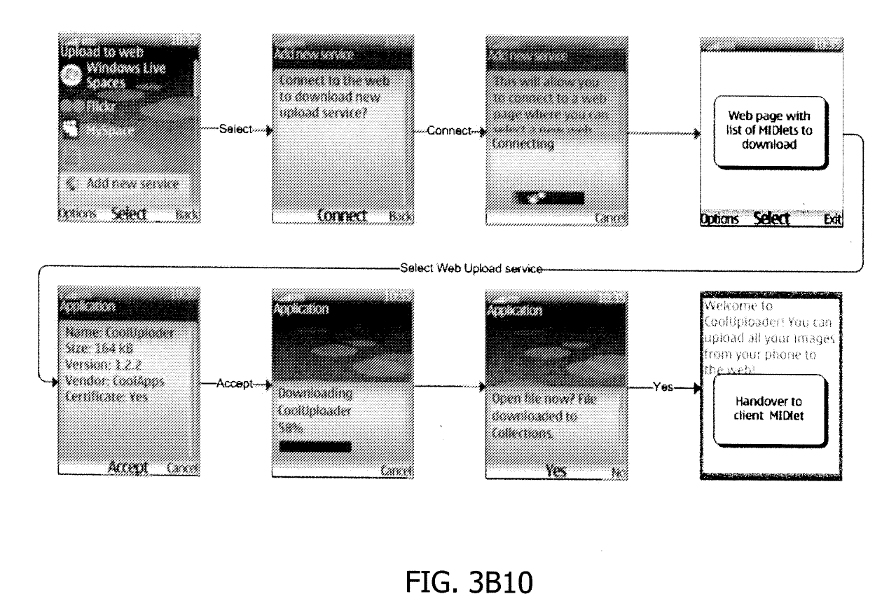

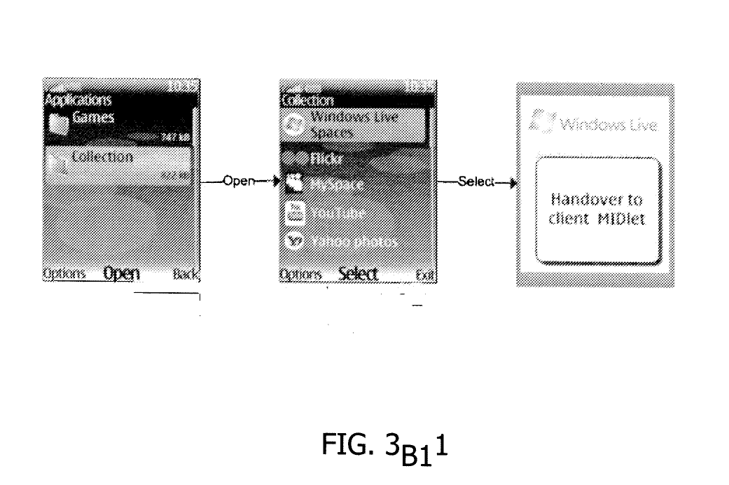

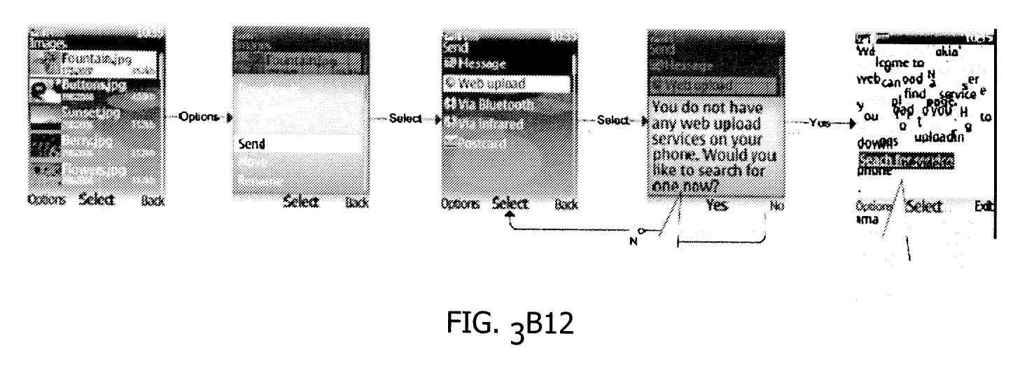

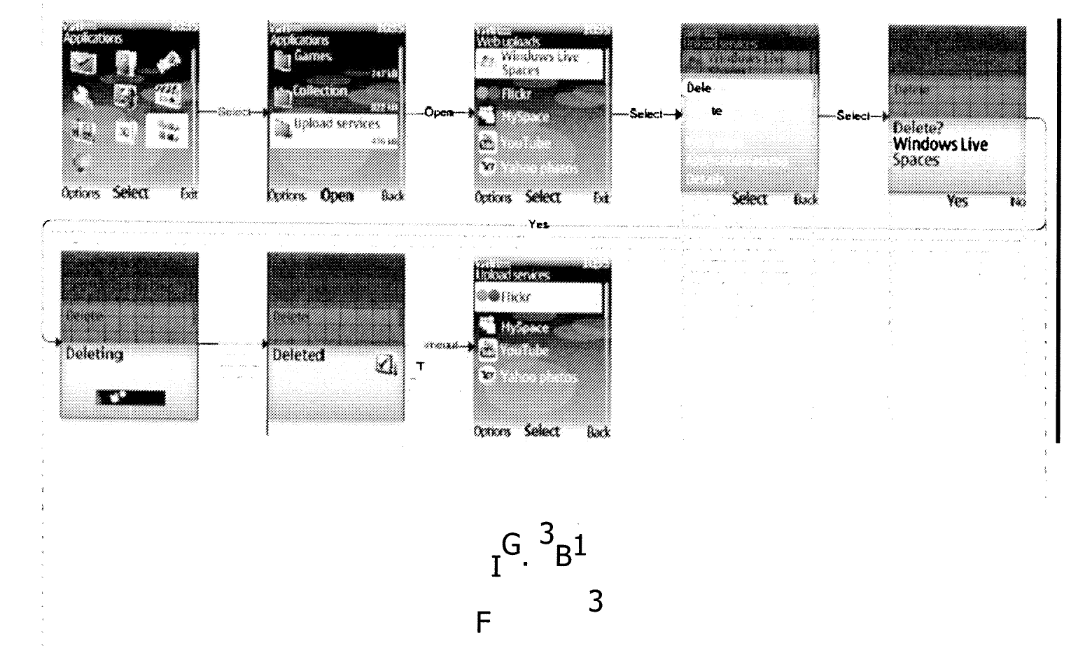

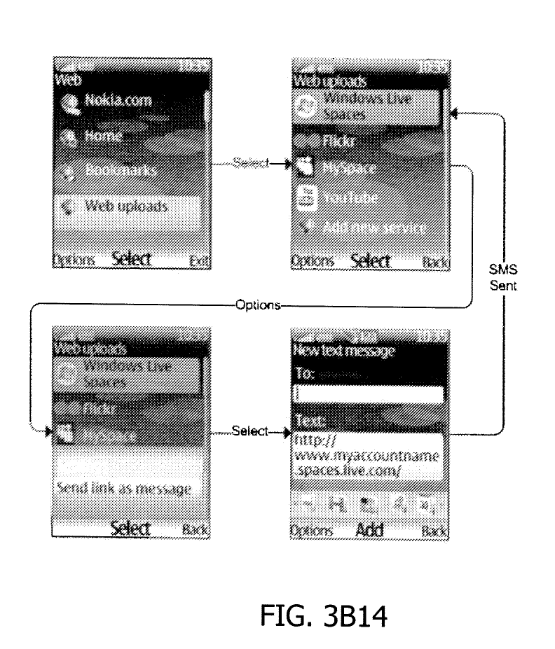

FIG. 3B1 is more illustrative of the above example. As shown in FIG. 3B1, the user captures an image B102. The image B102 can be captured in any suitable form or format. In this example, the particular device includes an image capture system, such as a camera. In another embodiment, the image B102 can be selected from a gallery of images stored in the device. Once the desired image B102 is selected, the user can activate the Send option B104 to enable a transfer of the image to a desired storage location or service. In this embodiment, a Send options menu B106 is presented that includes one or more transfer options, including the Orange™ ePhoto carrier option B108. The user highlights the icon B108 for this desired service and activates the Select B110 option. In other embodiments, any suitable process can be used to select the desired send or transfer option, such as for example, double-clicking on the selected icon. As shown in FIG. 3B1, once the transfer mechanism is selected, in this example the carrier service B108, the device automatically connects with the service as shown by the screen B112. As shown in screen B112, the particular client MIDlet program is displayed and the transfer of the image to the service can take place in any suitable manner. A MIDlet program is generally a Java™ program for embedded devices, such as games and applications that run on a cellphone or similar mobile device. In alternate embodiments, any suitable client application configured for the particular device can be used. In one embodiment, the transfer process can be fully automated, not requiring any further user input, or the user can be prompted for user input to enable the transfer steps to take place. A settings menu of the device can be configured in any desired fashion to enable the transfer or upload to take place in a manner consistent with the user's preferences.

FIG. 3B2 is another example of uploading or transferring an image from a device, such as for example a mobile phone, to an image processing and/or storage carrier or service. An image B202 is selected or captured as shown in screen B201. The image file B202 is designated in a suitable manner, such as for example image001.jpg, and this identifier B204 is displayed in a suitable position on the screen B201. After activating the Send option B206 an Options menu B208 is presented on the display that allows the user to select an action to be taken with respect to the captured image B202. The Options menu B208 can be presented in any suitable manner, including for example as a pop-window or in an area on the current display or menu region. In this example, the user selects the Send action option B210, in order to transfer the image B202 from the device to a desired upload service or account. Once the Send option B210 is selected in a suitable fashion, the Send options menu B212 is presented. One or more content send, upload or transfer options are presented in menu B212. In this example, the user selects the “Upload to web” send option B214 as shown. For these examples, the selected option is highlighted in any suitable manner to enable the user to easily distinguish a selected option(s) from a non-selected option(s). Although the examples herein are described with reference to selecting only a single send option, in alternate embodiments, one or more send options can be selected or deselected.

Once the Upload to web option B214 is activated, the user is presented with the one or more such service options that are supported or available in the device. Screen B216 displays particular services that are available. The services that are available can be highlighted or displayed in any suitable fashion to indicate to the user that the option is available to be selected. Services not supported, such as for example services that do not support the particular image file type, can be dimmed or de-emphasized. For example, selectable options can be brighter than non-selectable or unavailable options. In the options screen B216, a non-selectable option, such as option B222, is shown as dimmed or grayed relative to a selectable send option, such as option B220. In one embodiment, when a user selects content, such as an image to upload, the list of services will either include or highlight those services that support the file type associated with the selected content. The services that do not support the file type of the selected content could either not be displayed or could be grayed or dimmed out.

In this example of FIG. 3B2, the user selects the “Windows Live Spaces™” service option B218. Once the service B218 is selected, the device can launch the corresponding client program, such as a MIDlet, and automatically connect and handover to the service as shown in screen B224. The handover and transfer can occur according to any desired or suitable protocol. In one embodiment, when the MIDlet is exited, the device can return to the camera state or any other suitable state.

Referring to FIG. 3B3, the disclosed embodiments allow the user to select one or more images that are present or stored in the device for transfer or upload to an image processing and storage service. In this example, the user has accessed images stored in a memory or storage area of the device, referred to as a Gallery, as shown in screen B302. The user selects one or more images that are desired to be uploaded. In this example, the user has selected images B304, B306 and B308 for upload, as illustrated by the “check-mark” associated with each of the file icons. Non-selected images, such as image B310, are not marked. Any suitable mechanism can be used to “mark” an image that is selected for further action.

Once the user has selected and/or marked the desired images, the user can access the options tab B312 to access a menu of actions to take with respect the marked images. One example of such a menu is shown in screen B314. Any number and type of options can be presented on the menu. In accordance with the disclosed embodiments, a “Send Marked” option B316 is available to be selected. Since for purposes of this example, the user desires to send or transfer the selected images to a suitable web service, the “send marked” option B316 is selected. The available send options are then presented, as shown by screen B318. The “Upload to web” send option is selected, which leads to the presentation of the “Upload to web” menu B322. In the menu B322, the user is presented with the available web services that are available. The term “available” can generally mean or refer to a service that is active and on-line, has an on-line presence or that the file type of the selected content is compatible with the particular service. In this example, selection of the “Windows Live Spaces™” service icon B324 will cause the device to launch the corresponding MIDlet and connect to the selected service and present the user interface B326 for the upload service. In one embodiment, when the MIDlet for the Windows Live Spaces™ service is exited, the device can return to the previous marked list of images or gallery B302.

Referring to FIG. 3B4, an example is illustrated where the user has selected or marked both image and video file types for upload. In this embodiment, the image gallery B402 shows that both a video file B404 and an image file(s) B406 are marked. The user selects the send option B408 and the web upload option B410. Since some upload services will not support both types of files, in this embodiment, only the appropriate services will be displayed B414 or made available for selection. The user can be provided with a message B412 that advises the users that only suitable services will be selectable or displayed. This avoids the situation of selecting a service that does not support a particular file type. Alternatively, the user can be prompted to go back and unmark the unsupported file(s) or this can be done automatically by the system.

In one embodiment, an intermediary might be used between the device and the service application provider. The intermediary can configure the selected image(s) for the selected service provider. The sender delivers the content to the intermediary, which either adapts the content for a particular provider or selects a provider from among a group to which the user subscribes. In this fashion, the user does not have to be concerned with the compatibility of the file format and the service provider, and the content or images can be automatically uploaded as described herein.

The aspects of the disclosed embodiments also allow a user to view images that have been uploaded to a web service, such as a Windows Live Spaces account. For example, referring to FIG. 3B5, from a menu, such as menu B502, the user selects “Web Menu” B504 option. The menu presents one or more web connection options as shown in B506. Selection of “web uploads” B508 launches the Web uploads menu B510 from which the user can select the desired web service, or even add a new service. In this example, the user selects “Windows Live Spaces” B512, which launches the user interface B514 for the service and connects the device. From here, the user can view images stored with the user's on-line account in the service. In one embodiment, the browser can open to the URL specified in the MIDlet to go directly to viewing the user's stored images.

In one embodiment, referring to FIG. 3B6, the web menu B602 can present web options for the user to select from. In one embodiment, the menu B602 includes a selection for “Online sharing” B604, which might enable access to content sharing options when the user is involved with online collaboration, such as blogging for example. Accessing the “online sharing” options menu B606 can present and allow the user to select from content collaboration, sharing and transfer options, such as Web uploads B608, Blogs B610 and RSS B612, for example. In alternate embodiments, any such content sharing solutions can be included as part of the Online Sharing options menu B606.

The aspects of the disclosed embodiments also allow a user to access and change the settings for an online account or service from the device. One example is illustrated with respect to FIG. 3B7. From the web options menu B702, the user accesses or selects the Settings B704 option. The Settings Menu B706 allows the user to select and adjust one or more functions of the device. Selection of the Web uploads settings option B708 allows the user to access the menu B710 where specific services can be accessed and the service specific settings adjusted. In this example, the user desires to adjust and set the Windows Live Spaces™ settings. Selecting the Windows Live Spaces™ icon will open the client or browser in the settings mode B714 for the Windows Live Spaces™ service. The user can then enter the different menus and adjust the settings, which can include for example, log-in requirements, security settings, passwords and other user specific account settings.

Other examples of adjusting or changing settings for an on-line service account is shown with respect to FIGS. 3B8 and 3B9. In FIG. 3B8, the user is in the camera/gallery menu B802. An image has been captured or marked, and the Send option B804 is activated. The send options menu B806 is presented which allows the user to select the Upload to web B808 send option. From the Upload to web menu B810, the user selects a service, such as the Windows Live Spaces™ service icon B812. From the Options selection icon B813, the user can access the Settings menu B816 shown in screen B814. Selection of Settings B816 will open or launch the Setting Modes menu B808 for the Windows Live Spaces™ service. From here, the user can make the desired changes or settings.

In FIG. 3B9, the user has accessed or is in the Web menu B902. The Web uploads option B904 is selected. In this menu B906, a service is selected. For purposes of this example, the Windows Live Spaces™ service icon B908 is highlighted. The Options icon B910 is selected with causes the menu or pop-up B914 to be presented on the web uploads menu B912. By selecting Settings B916, the device browser launches the URL for the settings menu of the service, and causes the client to open in the settings mode menu B918. From here, the user can access and make changes to the settings menu of the service.

In the instance where the user's device is not configured with the particular MIDlet needed for a desired image upload to an on-line service, the disclosed embodiments allow the user to easily access and download a suitable or desired upload service. By accessing a Settings wizard for example, the user can search for, find and download a desired program or MIDlet. For example, referring to FIG. 3B10, the user selects the Add new service option B1004 from the menu B1002. It should be understood that the particular menu presentations are exemplary and for illustrative purposes only. In alternate embodiments, any suitable menu screens and layouts can be presented, and the options shown can be presented in any suitable order and fashion.

In the Add new service menu B1006, the user can select the option B1008 to connect to the web and download a new upload service. In alternate embodiments, any suitable process can be used to install the new service on the device, other than a download, including for example, using a computer readable medium such as a disc or floppy. In one embodiment, a menu B1010 can be presented that acknowledges that the user is connecting to a web page where the user can select a new web connecting/upload service. Once connected, the user can be presented with a menu B1012 that provides a list of service downloads, or MIDlets, that can be selected and downloaded to the device. Once example of such a download or MIDlet is shown in B1014. By selecting Accept B1015, or some other suitable activation, the program can be downloaded from the web to the device. In one embodiment, a user can be presented with a series of screens B1016, B1018 and B1020 that monitor and complete the download process. In alternate embodiments, the installation and download can be controlled by any suitable application, such as for example, a Java application download.

In one embodiment, the user can be prompted to download an upload service during an attempt to transfer or upload an image. Referring to FIG. 3B12, the user selects an image B1202 to upload. Once the image B1202 is selected, the user can select the send option B1206 and then the Web upload option B1210 to upload the image. However, in this example, the user does not have any web upload services installed on the device and this is presented to the user in a pop-up message B1212. If the user desires to search for a service, the user is directed to a suitable web upload program search page, such as page B1214. Selecting the search function B1216 will open the device browser to a page than includes service programs or MIDlets that are available to download. In alternate embodiments, any suitable process can be used to search for and download a desired program.

FIG. 3B11 illustrates the situation where the user is able to check for an update to a currently installed upload program or MIDlet. In one embodiment, the user accesses the Applications menu B1102 of the device. The folder named Collection B1104 includes the programs for the particular upload services. In alternate embodiments, any suitable folder or storage location can be used. For example, a separate folder named Upload services could be used to store the web upload programs. In one embodiment, the Applications menu B1106 can include an object for each upload service.

In the embodiment where the program objects are stored in the Collection menu, from the Collection menu B1106, the user can select a specific service B1108 and connect to the web and the particular service B1110 to check for updates. As illustrated in B1106, selecting the Windows Live Spaces™ object B1108 opens the corresponding MIDlet and the handover to the client MIDlet takes place. In one embodiment, the MIDlet can open to a viewing mode or to show the status of the current upload task.

Deleting a downloaded MIDlet from the device can be carried out in any suitable fashion. One embodiment of a deleting process is illustrated in FIG. 3B13. By navigating from the Applications menu B1302 to the Upload Service folder B1304, the user can access all of the stored programs B1306 and select a particular program B1308 to be deleted. The user selects Delete B1310 from the options menu. The steps in the deletion process are illustrated in B1312, B1314 and B1316. Once the program is deleted, the remaining list of programs B1318 will not include the deleted program.

The disclosed embodiments can also be used to send a link or other message to the user upload service account using a short message service (SMS). Referring to FIG. 3B14, the user goes to the Web menu B1402 of the device and selects the Web uploads option B1404 to take the user to the Web uploads menu B1406. From the web uploads menu B1406, the user highlights the desired service B1408 and activates the Options B1410. The options include a “send link as message” option B1412, which when selected opens a message composer, such as New text message screen B1414. As shown, the URL for the desired service is automatically inserted in the text field B1416. Once the message is sent, the device can automatically return to the web uploads menu B1406.

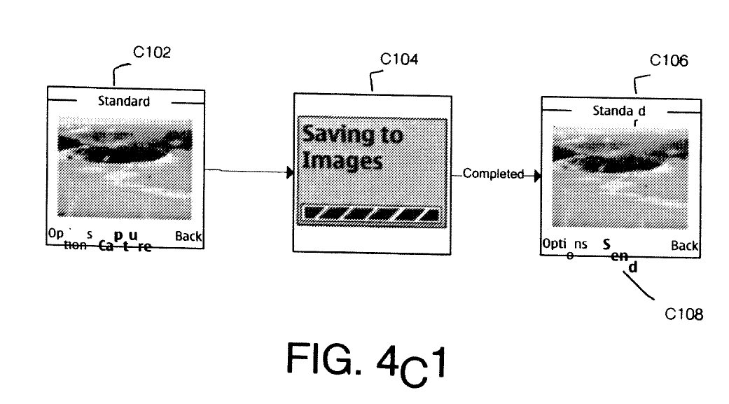

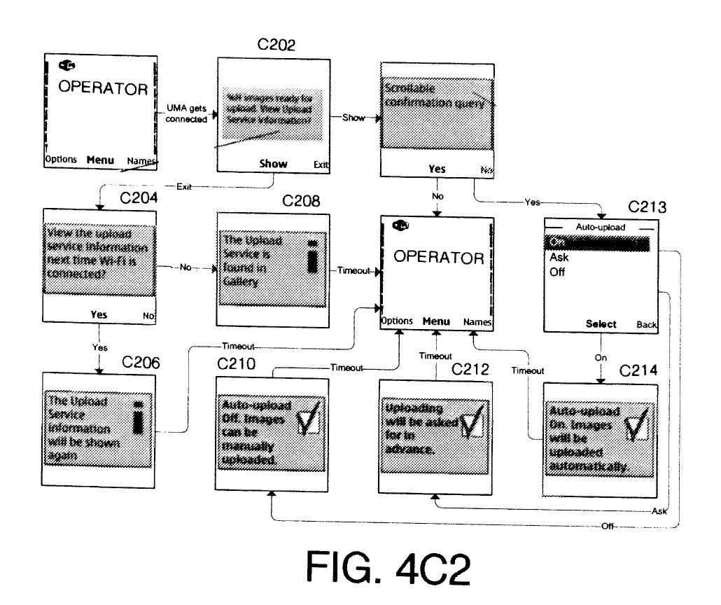

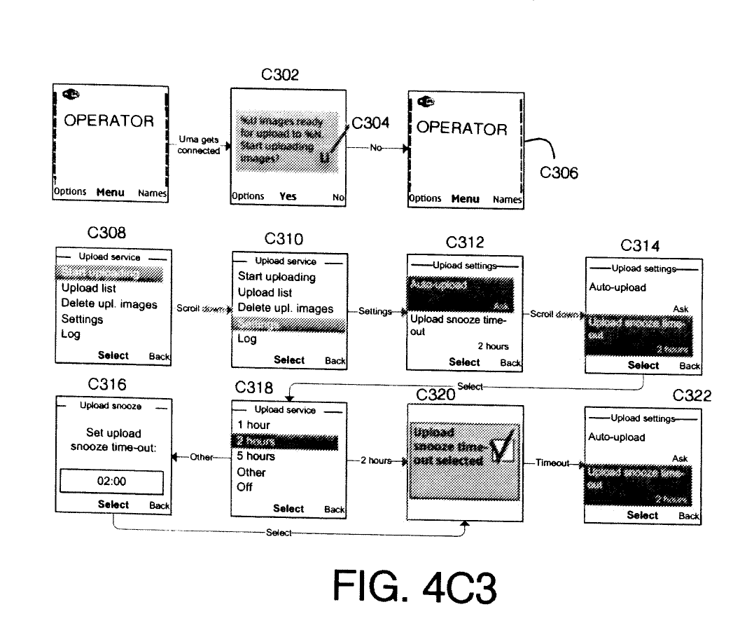

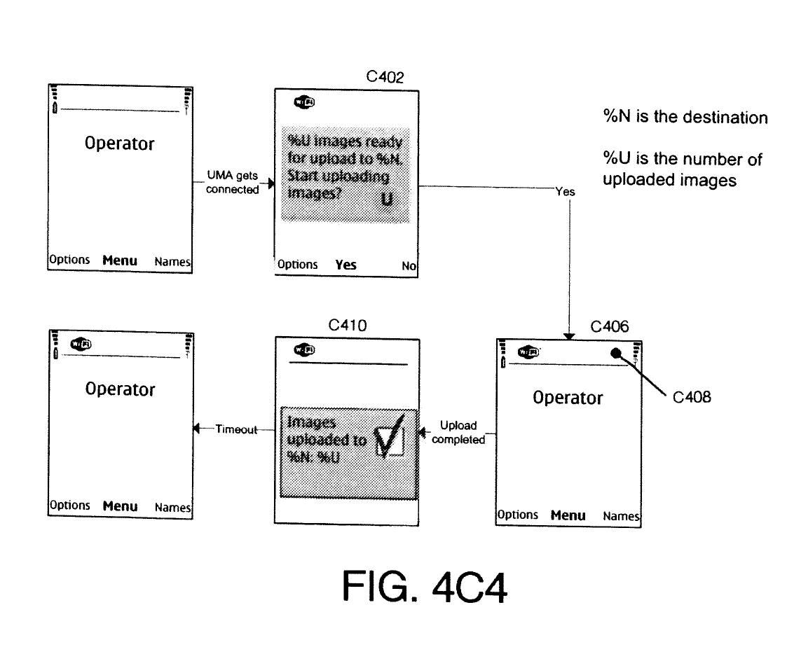

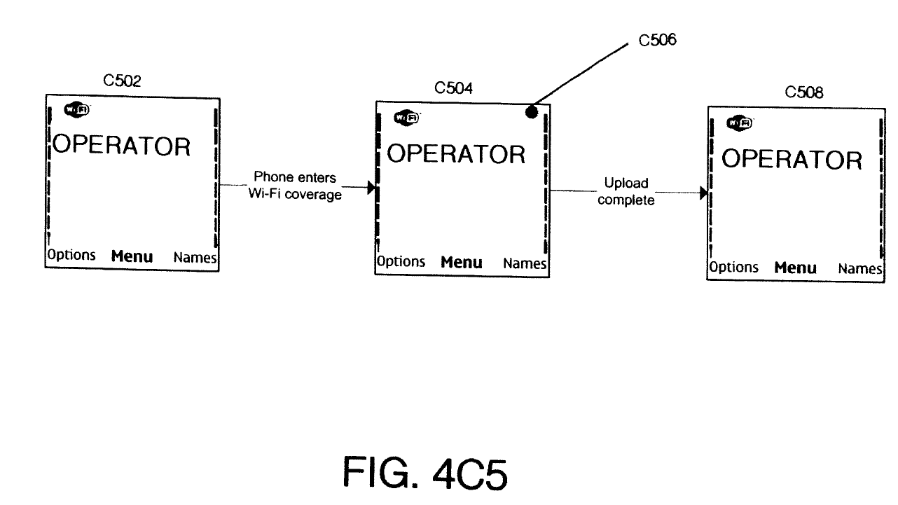

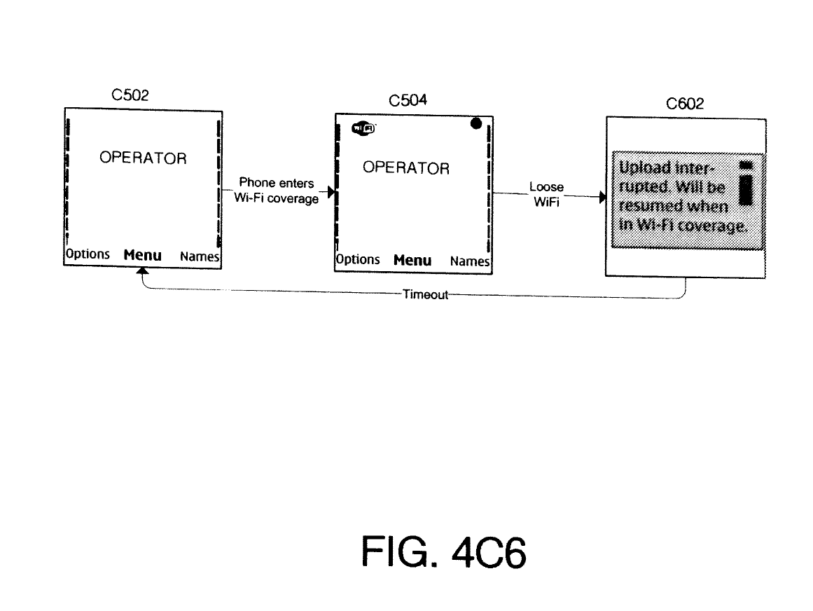

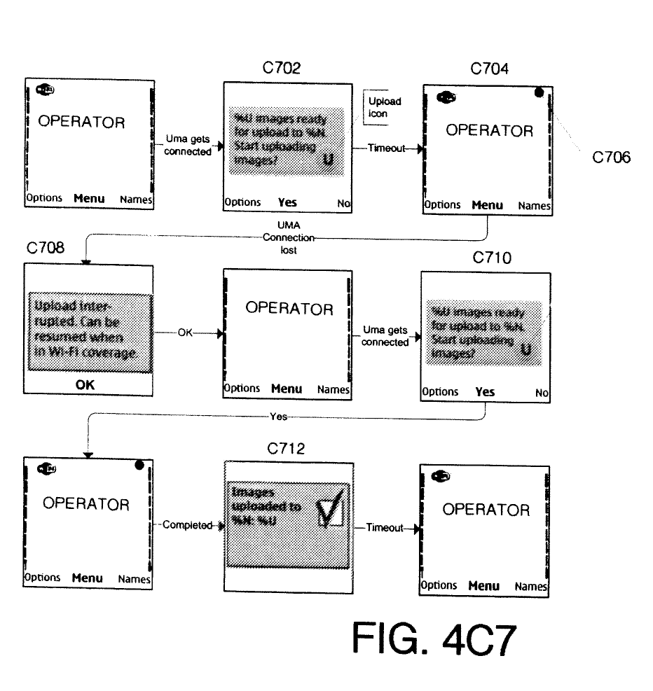

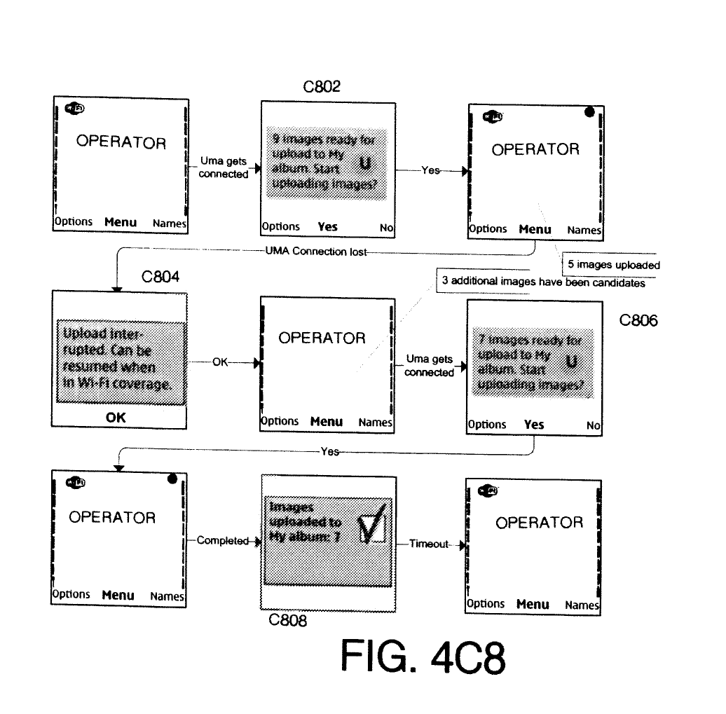

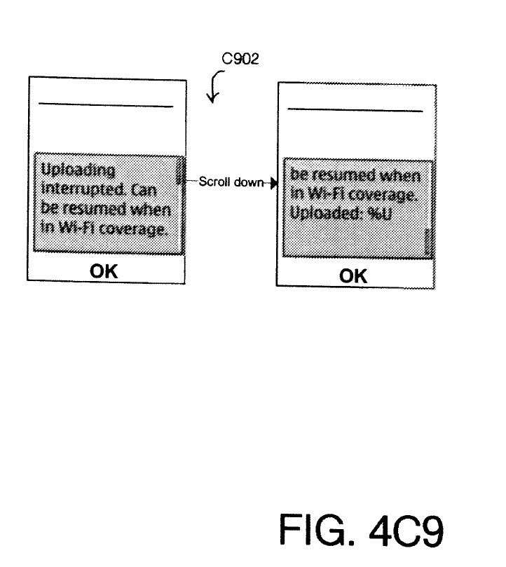

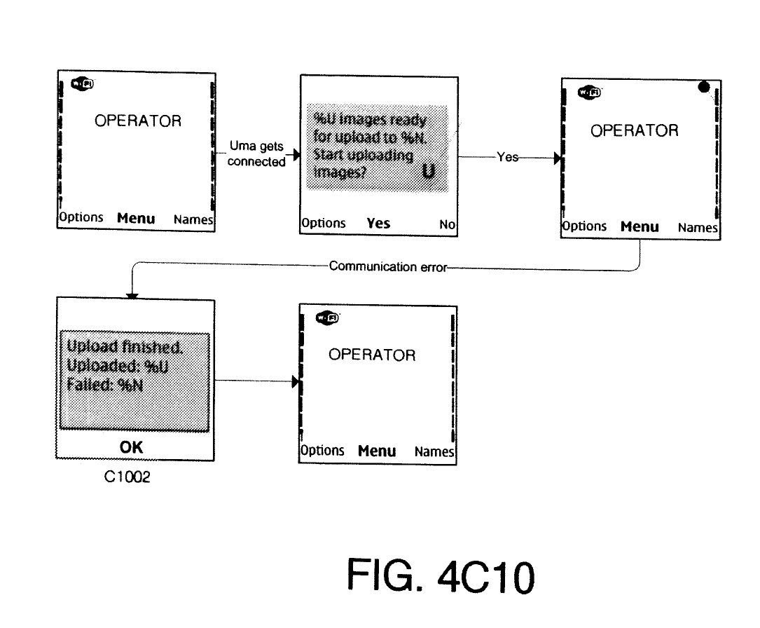

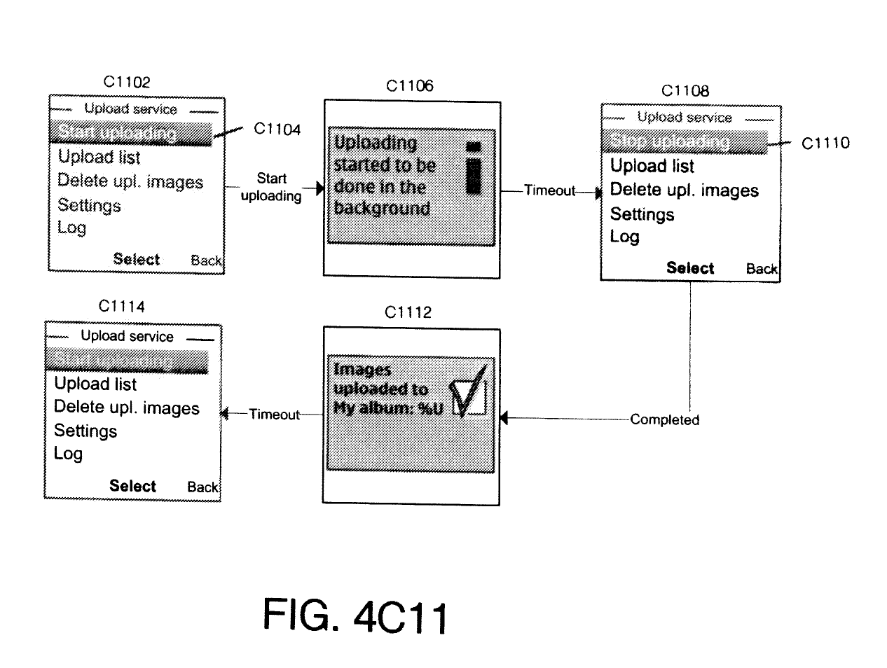

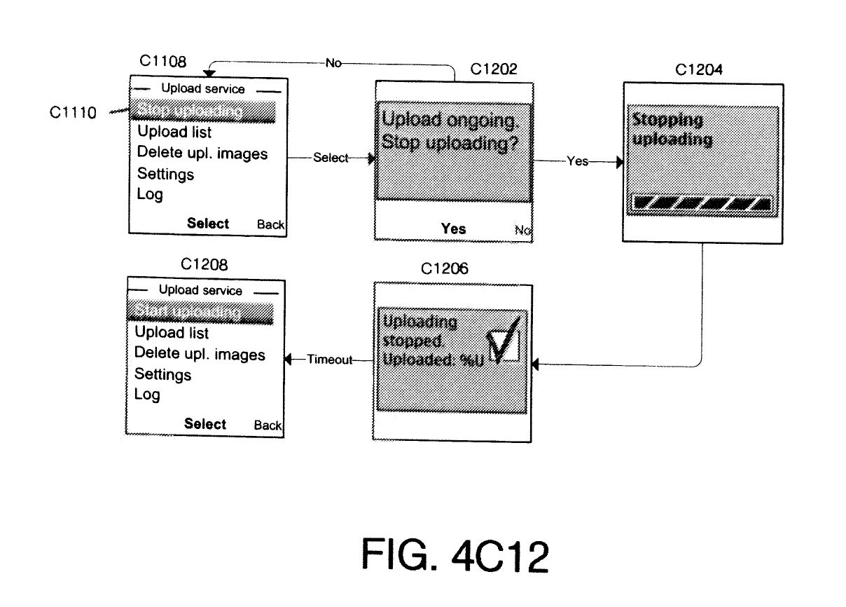

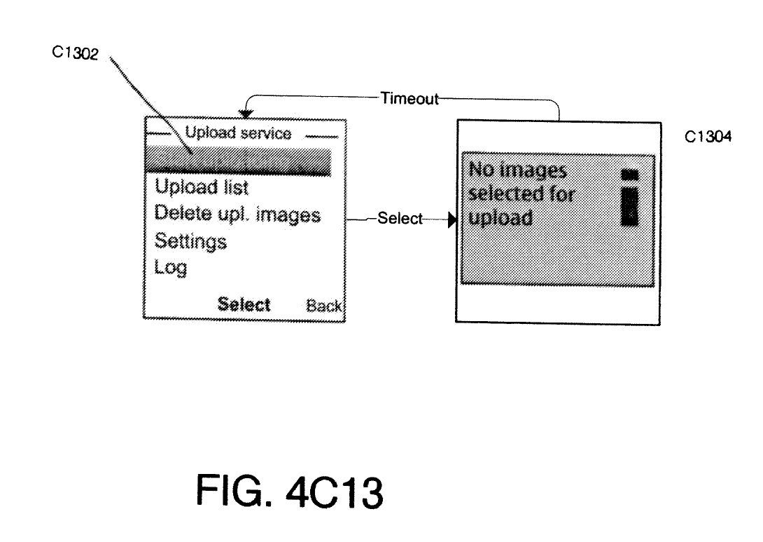

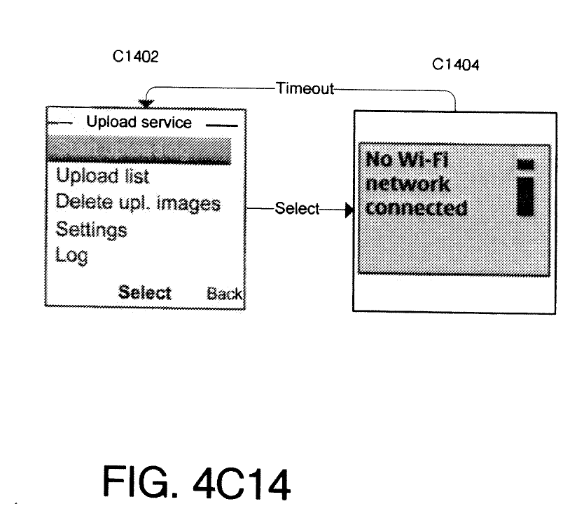

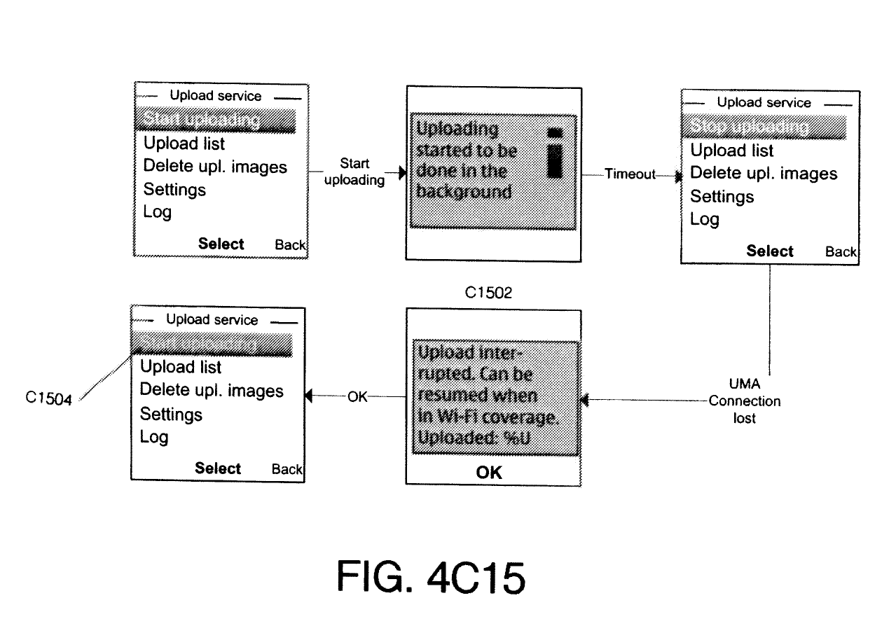

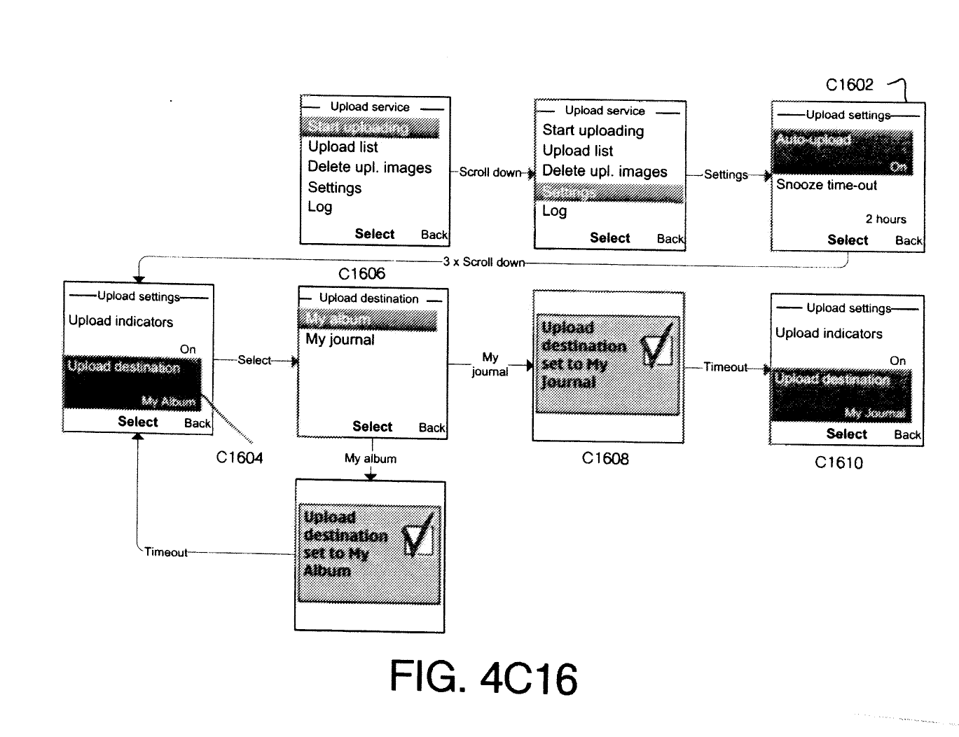

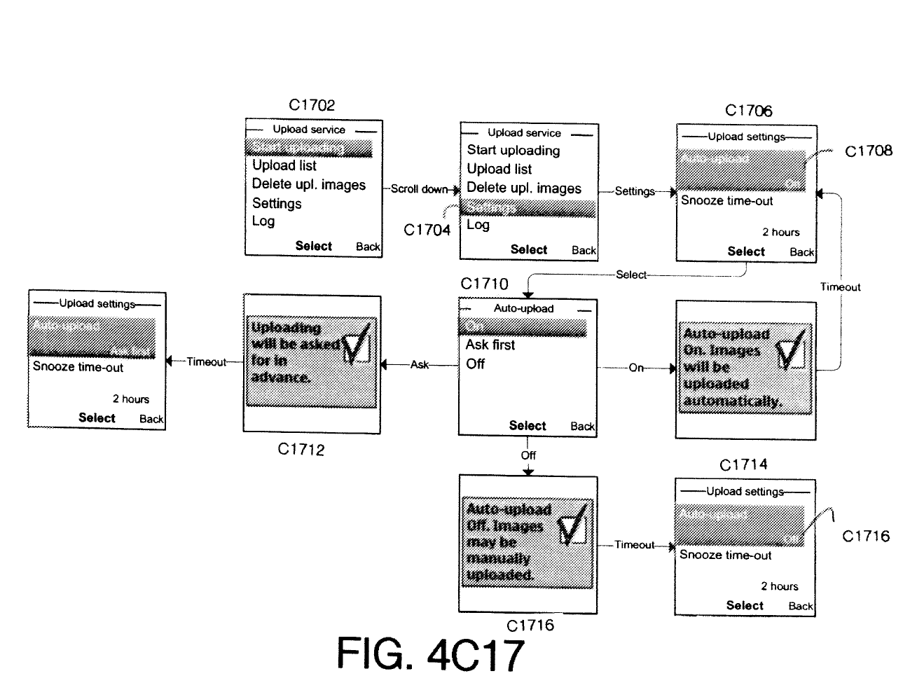

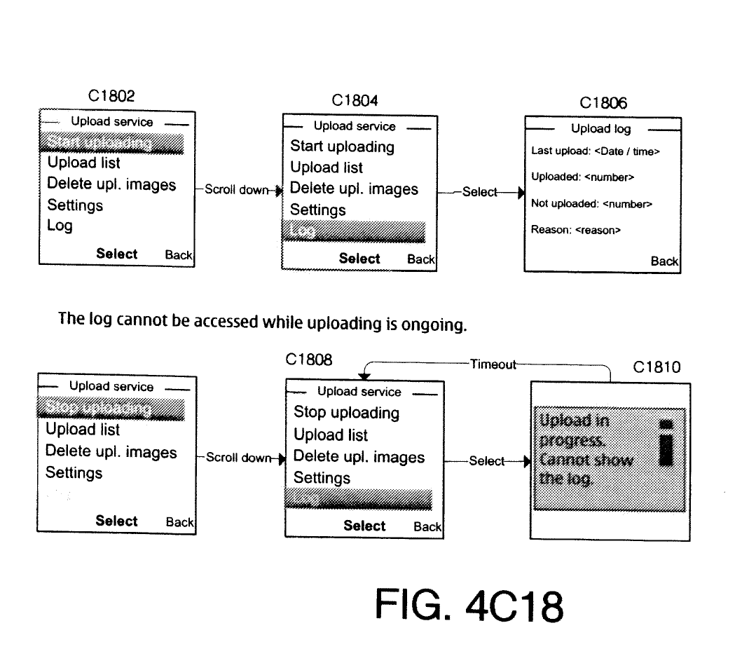

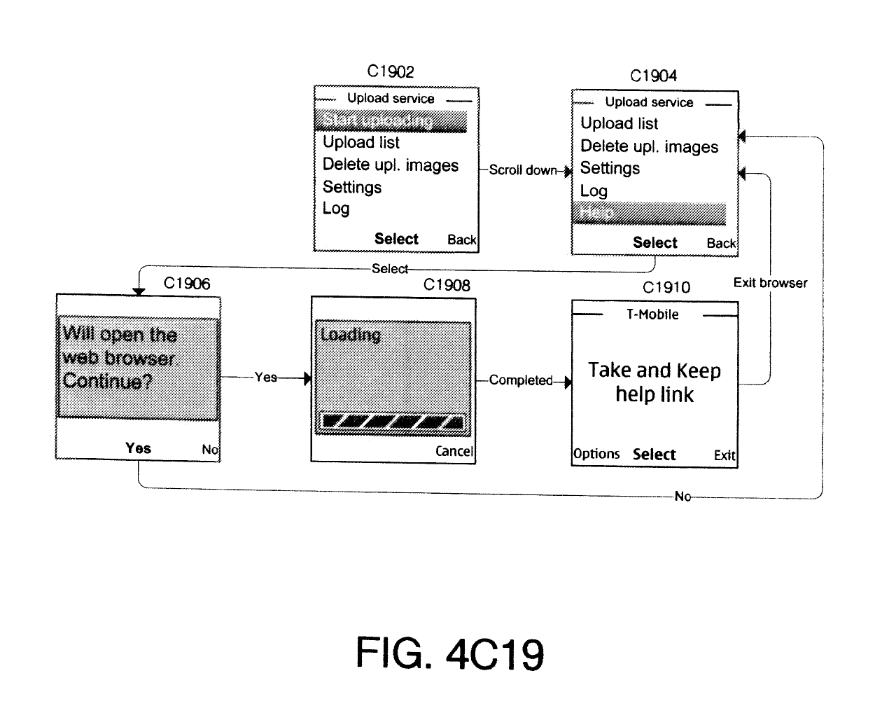

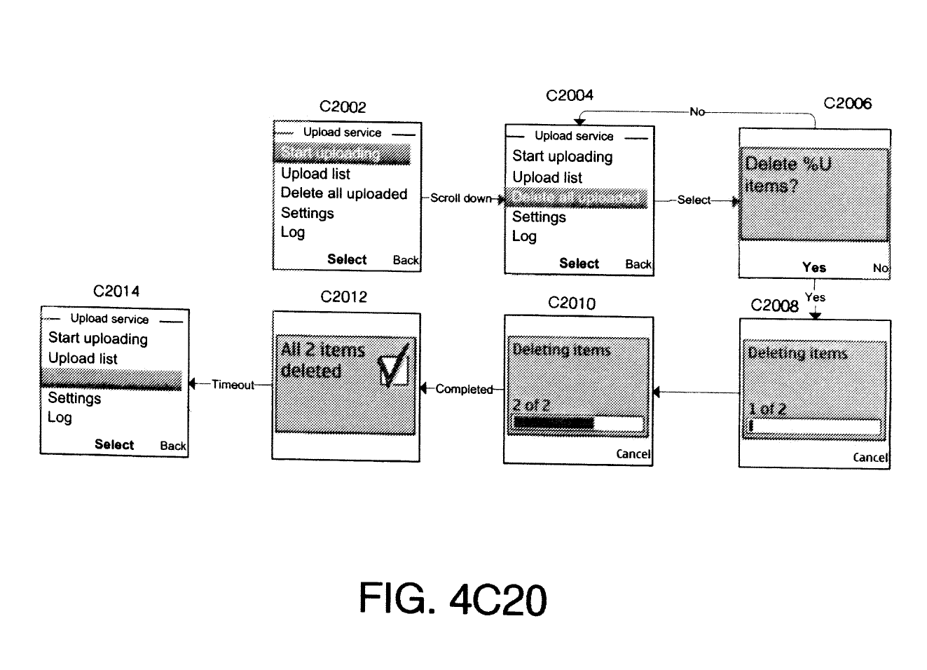

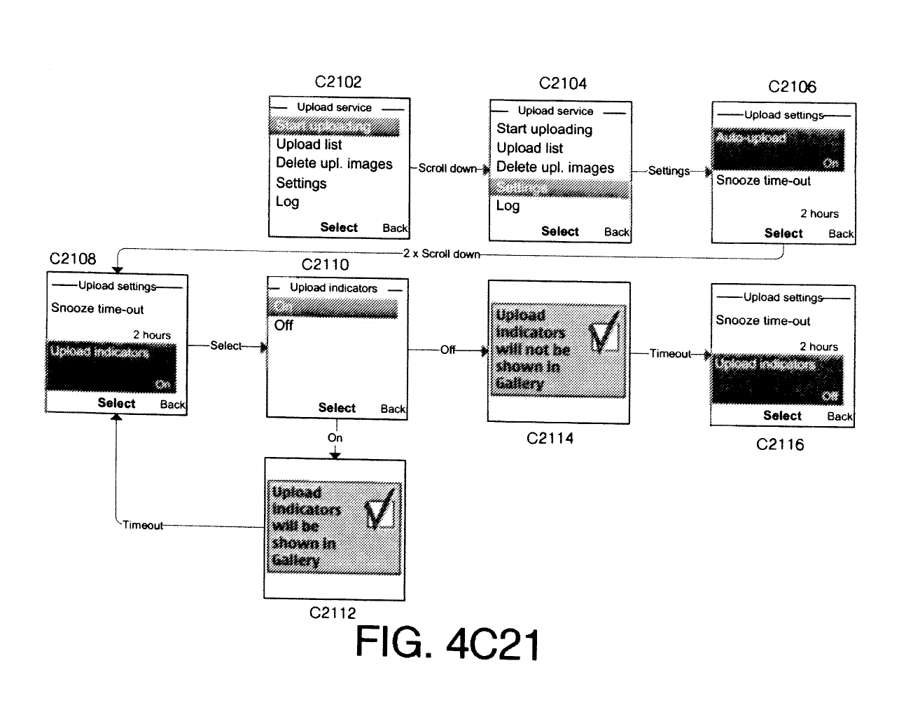

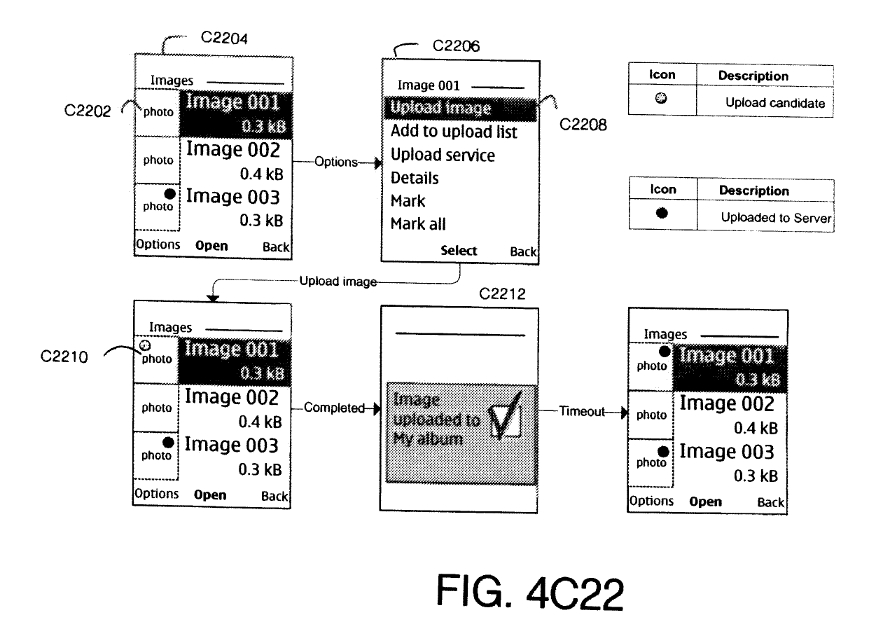

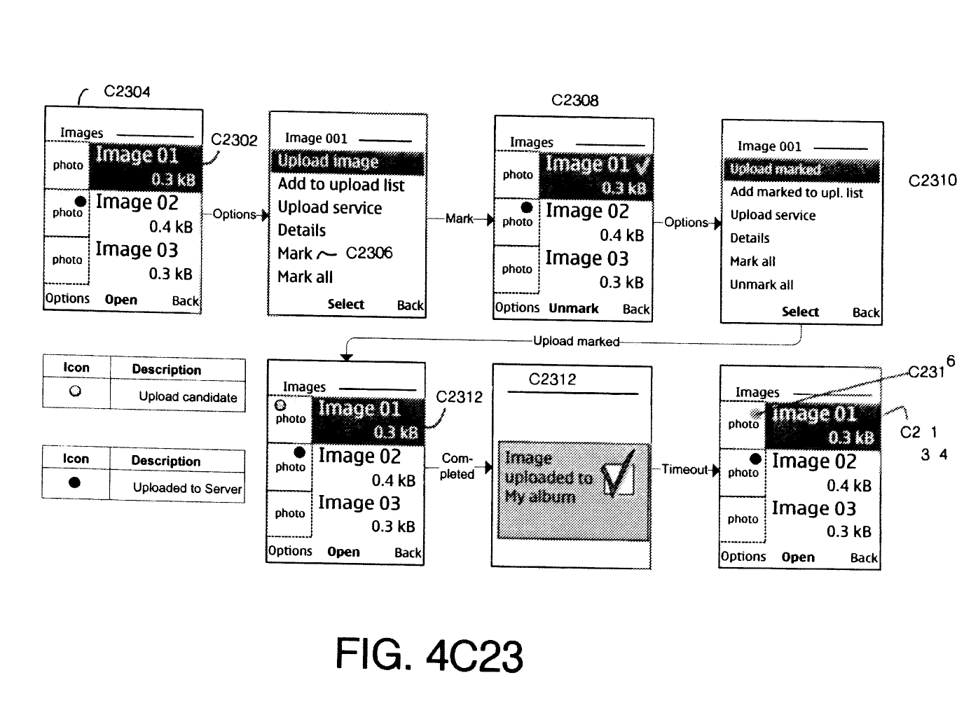

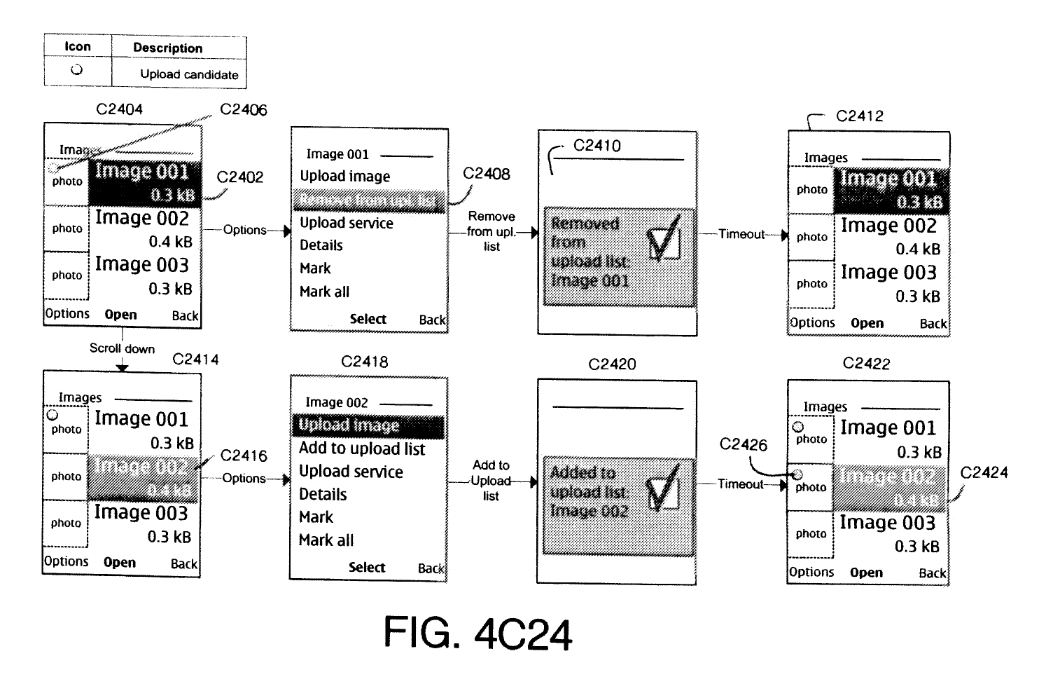

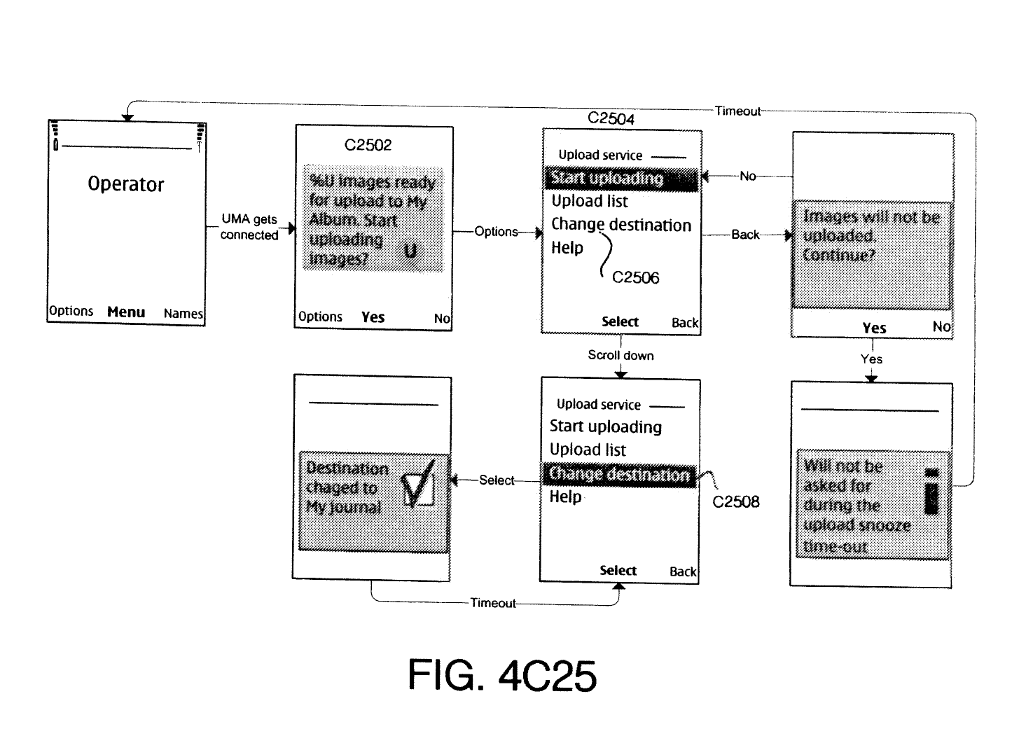

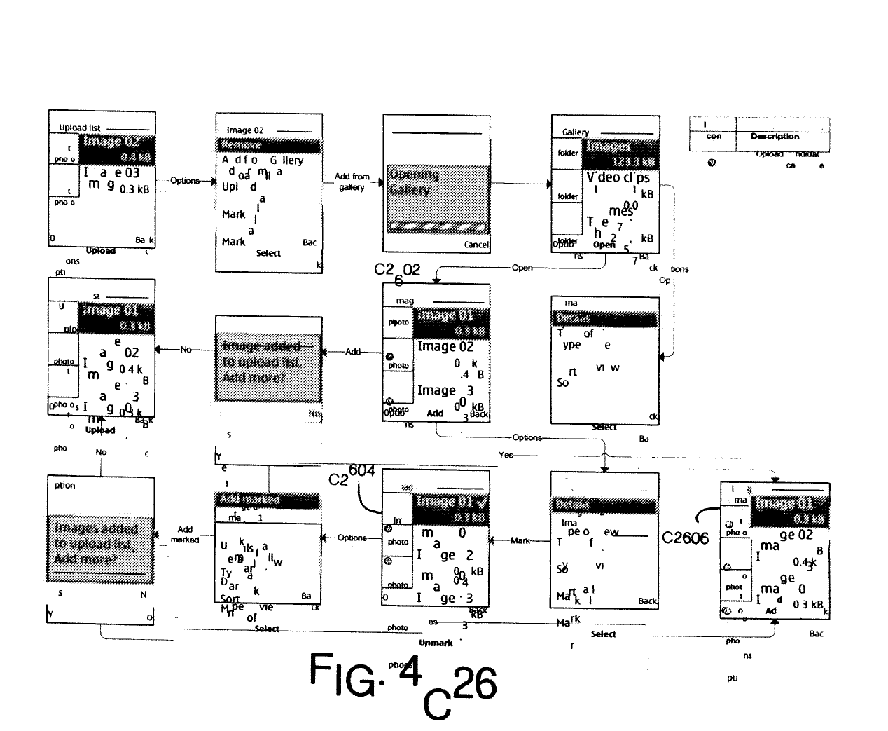

In the prior embodiments, when an image is desired to be uploaded, it is marked or otherwise selected or designated by the user for upload. In one embodiment, when an image is captured by the device, it is automatically marked as an upload candidate and placed in an upload list. The image can be stored in the device or on an external storage facility. For example, referring to FIG. 4C1, an image is captured C101 by the camera in the device. The image is stored C102 to a designated storage location. The image is automatically marked C104 as an upload candidate, and the “send” option C106 is presented to the user.

The auto-upload feature of the disclosed embodiments can be set by the user. Referring to FIG. 4C2, a message C202 can be presented to the user identifying that images are ready for upload and provide the user with the opportunity to view upload service information. The message C202 can be prompted by any one or more of a number of factors, including for example, a connection to a network, a time of day, location, cell identifier, network identification, or a profile. In alternate embodiments, any suitable action or activity can be used to prompt the message C202.

In one embodiment, the user has the option C204 to select to view C206 service information each time the device is connected to the network. If the user chooses not to view the upload service information each time the device connects, the upload service information is stored and can be accessed C208 from the device memory, such as for example the Gallery.

FIG. 4C17 illustrates an example of how the Auto-upload setting can be set. In the upload service client C1702 the user can select the settings option C1704. In the Upload Settings menu C1706, the user can view and change the Auto-upload settings C1708 and C1710. As shown, from within this setting menu selection option C1710 the user can select to Ask first C1712 prior to uploading, initiate only manually C1716 or initiate uploading automatically C1714. The selected option is then displayed in the settings menu as shown in C1716, for example.

The aspects of the disclosed embodiments allow the user to upload images to a memory location, such for example the My Album or My Journal folders of a storage facility. Referring to FIG. 4C16, in one embodiment the user accesses the Upload settings menu C1602 of the Upload service. The Upload settings menu C1602 can include a setting for the Upload destination C1604. By accessing the Upload destination menu C1606, the user can view and select an appropriate location for uploaded images to be stored. Here the user selects the My Journal folder, which is confirmed C1608 to the user and is reflected in the settings menu C1610. In alternate embodiments, any suitable destination or storage location can be incorporated and designated in a settings menu for storage of the uploaded images. This way the user does not need to be concerned about memory storage limitations of the device, such as for example a mobile communication device. The images can be uploaded manually, or in one embodiment, automatically, when the device is connected.

As shown in FIG. 4C2, when the auto-upload function is not active, the user can manually select C210 to upload images. One example of such a manual process is shown with respect to FIG. 4C22. In this example, image C2202 is selected from images in an image folder C2204. From the Options menu C2206, the user selects the Upload image C2208 option. In one embodiment, the image folder C2204 may only display the image(s), without the name or file type, and an image can be marked as an upload candidate directly from the image folder C2204. The selected image C2208 is marked for upload as shown by C2210 and the image is uploaded C2212. In this particular example, image 003 has already been uploaded, as indicated by the black dot. Therefore, it is not marked for upload.

FIG. 4C23 illustrates the situation when images that are marked for upload are manually uploaded. In this example, an image C2302 is selected from the image folder C2304. The Mark option C2306 is selected and the image is marked C2308. When the Upload marked option C2310 is selected, the marked image C2312 is uploaded. When the upload is complete C2314, the image file C2314 has an Uploaded to Server indicator C2316 associated with it. In this example, the indicator or dot is filled, or black. In alternate embodiments, any suitable indicator can be used to indicate that the image file has been uploaded.

Images can easily be added to and removed from the upload list in accordance with the aspects of the disclosed embodiments. Referring to FIG. 4C24 for example, an image C2402 is indicated by indicator C2406 as being an upload candidate. The image C2402 selected from folder C2404 and the Remove from upload list option C2408 is selected. Once the image C2402 is removed from the upload list, the user receives a suitable notification C2408 and the upload indicator C2406 is removed from the identifier C2410 as shown in screen C2412.

To add an image to the upload list, the user selects the image 2416 from the image folder C2414 and selects the Upload image option C2418. The user is notified C2420 that the image has been added and the image file C2424 in the folder C2422 is marked with a suitable upload indicator C2426.

FIG. 4C26 illustrates a situation where more than one image can be marked as an upload candidate at the same time. In this example, the user navigates the menu structure to arrive at the folder where the desired files are stored. Here it is the images folder C2602. The folder can contain only the images, or thumbnails thereof, a file name, or both. The user can add the image C2604 by marking the image or file. The process can continue until all desired images are marked as upload candidates. When all the desired images are added, they can include an upload candidate indicator C2606.

When the auto-upload function is active C213, the images will automatically be uploaded C214 when the device is connected. In one embodiment, the user can be prompted C212 as to whether to upload the images once the device is connected.

Referring to FIG. 4C3, when the auto-upload function is set to “ask”, the upload prompt is triggered based on a number of pre-set rules and conditions. The “Ask” prompt C302 is shown when there are new candidates for upload and the device is connected. An upload icon C304 can be provided that would allow the user to easily and quickly activate the upload function. In alternate embodiments, any suitable icon or object can be used to allow the user to access the upload function. If the user declines the upload option, the device returns C306 to its prior operation. In this case where the prompt is rejected, the prompt will not be shown again until there are new candidates and the device is connected.

If the upload prompt is accepted, the upload of the images will begin. If the upload process is interrupted, the user will receive another prompt the next time the device is within the coverage area. In the case where the interrupt is user initiated, the upload process may not resume until there are new images ready for upload, the device is again connected, if the connection is interrupted. In one embodiment, the user can manually reinitiate the upload process.

FIG. 4C3 also illustrates how a “snooze” function can be set with respect to the upload function. From the upload service menu C308 the user accesses the Settings function C310. In the Upload Settings menu C312, the user can select the Upload time-out function C314. During this period, no upload prompts will be shown. The user can then set a desired period or interval as shown in C316, C318, C320 and C322. In one embodiment, the “snooze” time period can begin when the user activates “snooze” at the upload prompt. Alternatively, the snooze time period can begin from the point when the device is connected or after the first time the user has agreed that the system can upload the content, the first request approval. Generally, a user might choose to be prompted each time there is content to be uploaded and an upload connection is established. In a situation where the user may not wish to receive these prompts and confirmations, the snooze function can be activated from the upload prompt C302. The snooze function can be also be activated based on time of day or time period, a location of the device, or a connection to a certain network. In alternate embodiments, any suitable criteria can be used to activate the snooze function, and these can be automatic or manual.

Other prompt options could include allowing the user to select or change the destination for the uploaded images. For example, referring to FIG. 4C25, in one embodiment, the user selects the Options menu from the prompt screen C2520. Among the available options in the options screen C2504 is a Change destination option C2506. Selection C2508 of this option allows the user to change the destination. Alternatively, in one embodiment, the destination location selection can be presented to the user when the image is marked for upload. When the user marks the image(s) or file(s), a prompt appears asking the user to make a destination selection. In other embodiments, the destination selection can be presented to the user at any point in the selection and upload process.

FIG. 4C4 illustrates an example of a situation where the auto-upload setting is set to “Ask”. When the device gets connected, either automatically or manually, the upload soft notification prompt is triggered. As shown in FIG. 4C4, when a device connection is established, a screen prompt C402 asks the user whether or not to start uploading images. The term % U as used here represents the number of images marked to be uploaded. The term % N is the destination for the upload. If the user selects “Yes”, the upload automatically begins C406. Any suitable upload indicator, such as C408, can be displayed while the upload is ongoing, if such a progress notification is desired. Once the upload is complete, a notification C410 can be provided to the user.

In one embodiment, the prompt C402 may not be accompanied by any audible notification. In some instances, it may not be necessary or desirable to interrupt the user and the activity that they are currently involved with. In alternate embodiments, the user can receive and be notified of the upload prompt in any suitable fashion. The upload process can be ended or interrupted in any suitable fashion, such as for example, activation of the End key on the device.

The upload indicators that indicate whether a file or image is selected for upload can be controlled from with the settings menu of the Upload service client. These upload indicators can be located adjacent to or near the image files or images in the folder. For example, referring to FIG. 4C21, in one embodiment the user accesses the upload service C2102 and selects the settings option C2104. From the Upload settings menu C2106, an Upload indicators option C2108 can be selected. The indicator can be turned on/off C2110 and an appropriate selection confirmation C2112, C2114, C2116 can be presented. The upload settings selection menu C2110 could also include options for audible and visual settings.

FIG. 4C5 is an example of a situation when the user has set the upload settings to “Automatic” and the connection mode setting of the device is also set to “Automatic”. The device has pending upload candidates, and the device, in this case a mobile communication device, enters into a coverage, such as a Wi-Fi coverage area for example. As shown in FIG. 4C5, the device is in normal operation C502. The device enters into the coverage area and automatically establishes a suitable connection. Since the upload settings are set to “Automatic” and there are pending images for upload, the images are automatically uploaded C504 to the pre-determined upload destination. An upload indicator or icon C506 can be displayed on a display of the device during the upload process. Once the upload is complete, the device resumes normal operation C508 and the icon C506 is no longer displayed.

In the event the connection is lost during the upload process described with reference to FIG. 4C5 and the upload is not complete, the upload indicator will not be displayed and a message C602 can be displayed as shown in FIG. 4C6. The message C602 can indicate that the upload process has been interrupted and will resume when coverage is re-established. Once the connection is re-established, the upload process will resume as described above.

In one embodiment, the message C602 can indicate the number of successful uploads and/or the number of pending uploads remaining. FIG. 4C8 illustrates one example of how the number of uploaded images and remaining image numbers can be presented. Initially, the user is advised C802 that there are 9 images available for upload. During the upload process, and interruption C804 is recognized. In this example, during the initial upload 5 images of the initial 9 were uploaded. In one embodiment, referring to FIG. 4C9, the user can be advised C902 as to the number of images uploaded prior to the interruption. The user can also be informed as to the number of images not uploaded and still pending.

In this example, during the interruption, an additional 3 images have been marked as upload candidates. When the connection is restored, the user is notified C806 that there are now 7 images ready for upload. In C804, the user can be advised as to how many images were uploaded prior to the interruption, which in this case is 5. When the process is complete, the user is advised in C808 as to the number of images uploaded after the interruption.

In the situation where the auto-upload setting is set to “Ask” and the connection is lost, a new prompt will be generated when the coverage or network connection is re-established. Referring to FIG. 4C7, when the coverage connection is first established, the prompt C702 advises the user that there is at least one image ready to upload and the user is offered the choice to proceed. During the upload C704, an upload indicator C706 is displayed. In the event there is an interruption in the upload process due to a lost of coverage or other disruption in the network connection, the user is so notified C708. When the connection is re-established, the user is once again prompted C710 to start uploading images. When the upload is complete, a completion message C712 can be provided. In one embodiment, the interrupt message C708 will continue to be presented until acknowledged by the user. In alternate embodiments, any suitable mechanism can be used to notify the user of the upload interruption.

Although the above examples have been directed to upload interruptions due to network coverage issues, there can be any number of reasons for an upload interruption or failure. FIG. 4C10 illustrates an example where the user is advised C1002 upon completion or termination of an upload how many images were uploaded and how many images were not. In one embodiment, the message C1002 will only be presented when the auto upload setting is set to “Ask” and the upload prompt is triggered. In alternate embodiments, such as when the device is in the “Auto” setting, the user may desire to receive such a completion message. The message C1002 could be presented to the user upon completion of the upload or at some other suitable time. In one embodiment, the message C1002 might be stored in a suitable upload results location for later retrieval or sent to the user at a suitable time as an SMS message or email.

FIG. 4C18 illustrates one example of a log for an upload session. From the upload service menu C1802, the user can select the log option C1804. In one embodiment the Upload log C1806 can provide information on the last upload, the number of uploads, the number of images not uploaded and the reasons therefore. In alternate embodiments, the upload log C1806 can include any suitable information. Generally, the upload log C1806 cannot be accessed while an upload is ongoing. If the user attempts to access the log during an upload, an error message C1810 can be displayed.

In one embodiment, referring to FIG. 4C11, when the user has valid settings set for the upload service, the user can initiate the upload from the device via the upload service. For example, in this example, the user has selected the Upload client and the device is connected. From the upload client C1102, the user selects C1104 to begin uploading images from the device. When the uploading begins, the user can be notified C1106 can be notified that uploading will take place in the background, to allow the user to undertake other activities. After the upload is started C1108 the user can be presented with additional option, including the ability to stop uploading C1110. In one embodiment, the number of uploaded images can be presented C1112 to the user, when the upload is complete. The user can return to the upload service client C1114 or other suitable application for further action.

In the event the user selects C110 to stop uploading, referring to FIG. C12, the user can be prompted C1202 to stop the upload. If the user proceeds to stop the upload, in one embodiment, a suitable stop notification C1204, C1206 can be provided. The user can also be presented with an identification of the number of images uploaded prior to the stop command, as well as an indication of how many images were not uploaded. The user can then be presented with the option C1208 to start or resume the upload.

In one embodiment, in the situation where the a network connection is available but there are no candidate images, the start upload feature can be disabled. For example, referring to FIG. 4C13, there are no candidate images available for upload. When the user connects to the upload service to upload images from the service, the “start uploading” selection C1302 will not be available. In this example, the option is dimmed or grayed to indicate it is not available or selectable. The user can also be advised C1304 via a message or pop-up prompt, for example, that there are no images selected for upload. In alternate embodiments, any suitable mechanism can be used to advise a user that there are no images available for upload.

Similarly, if the user has accessed the upload service client and there is no network coverage, the upload start selection can automatically be disabled. As shown in FIG. 4C14, the user has valid settings set for the upload service client. However, there is no network coverage or connection. The start upload selection in C1402 is automatically dimmed or grayed, and if an attempt is made to select that option, a message C1404 can be presented to the user that a network connection is not available.

FIG. 4C15 illustrates the situation where the user has initiated the image upload from within the upload service and the network connection is lost. The user can be notified C1502 that the upload is interrupted. Until the network connection is restored, the Start upload option C1504 will remain non-selectable.

The disclosed embodiments allow the user to access online upload help. Referring to FIG. 4C19, from the upload service client C1902, the user selects the help option C1904. The user can be presented with an option C1906 to open the help browser, which then loads C1908 and takes the user to the help function C1910.

The disclosed embodiments also allow the user to delete files that are uploaded from the device. In one embodiment, referring to FIG. 4C20, the user accesses the Upload service client C2002 and selects the delete option C2004. In this example, a delete “all” option has been selected and there are two uploads to be deleted. The user is prompted C2006 for an affirmative response, and the delete process begins C2008. The progress can be shown in any suitable fashion C2010 and 2012. When there are no items to delete, the delete option C2014 can be dimmed or grayed out. In one embodiment, the delete option C2004 can be selected during an ongoing upload. The files deleted will be the ones that are uploaded at the time the delete all option C2004 is selected C2006.

Alternatively, if the user desires to reduce the amount of storage area that is occupied by the images that are uploaded, the user can select a delete function, where the images that have been uploaded are replaced by thumbnails of each original image. The thumbnails require less storage area than the original content, and provide a space saving advantage. In one embodiment, a setting in the device can be activated that would cause the device to automatically upload images that are not already uploaded, and create thumbnails of the uploaded images. The uploaded images cold also be deleted from the device as a storage space saving feature. In one embodiment, this might be referred to as a back-up now feature.

Referring to FIG. 1, the system of the disclosed embodiments can include an input device 104, output device 106, navigation module 122, applications area 180, and storage/memory device 182. The components described herein are merely exemplary and are not intended to encompass all components that can be included in the system 100. In one embodiment, the system 100 comprises a mobile communication device that is Internet enabled. The input device 104 can include a camera or such other image capturing system. The applications of the device may include, but are not limited to, data acquisition (e.g. image, video and sound) and multimedia players (e.g. video and music players). Content might also include text documents, spreadsheets, calendar information, contact data, message and calendar attachments, notes, favorites and other downloadable content items. In alternate embodiments, the system 100 can include other suitable devices and applications for capturing and storing images and transferring the images to an online service.

The system 100 can also include an upload module or engine 136 and a transfer options/service engine 138. In one embodiment the upload module 136 is configured to control the transfer of content from the device to the upload service or destination as described herein. Upload settings and controls can be configured via the upload module 136. The disclosed embodiments can also include a transfer engine 138 that interfaces between the device 100 and the upload service or storage destination. In one embodiment, all communication protocols, security, access and controls as described herein can be set and controlled via the transfer engine 138. In one embodiment the upload module 136 and transfer options engine will form part of the process module 122.

While the input device 104 and output device 106 are shown as separate devices, in one embodiment, the input device 104 and output device 106 can be combined and be part of, and form, the user interface 102. The user interface 102 can be used to display information pertaining to multi-media content as will be described below.

In one embodiment, the user interface of the disclosed embodiments can be implemented on or in a device that includes a touch screen display or a proximity screen device. In alternate embodiments, the aspects of the user interface disclosed herein could be embodied on any suitable device that will display information and allow the selection and activation of applications or system content. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to encompass that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

Examples of devices on which aspects of the disclosed embodiments can be practiced are illustrated with respect to FIGS. 5A and 5B. The terminal or mobile communications device 900 may have a keypad 910 and a display 920. The keypad 910 may include any suitable user input devices such as, for example, a multi-function/scroll key 930, soft keys 931, 932, a call key 933, an end call key 934 and alphanumeric keys 935. In one embodiment, the device 900 includes an image capture device such as a camera 921. The display 920 may be any suitable display, such as for example, a touch screen display or graphical user interface. In one embodiment, the display 920 can be configured to display both two-dimensional and three-dimensional images. The display may be integral to the device 900 or the display may be a peripheral display connected to the device 900. A pointing device, such as for example, a stylus, pen or simply the user's finger may be used with the display 920. In alternate embodiments any suitable pointing device may be used. In other alternate embodiments, the display may be a conventional display. The device 900 may also include other suitable features such as, for example a loud speaker, connectivity port or tactile feedback features. The mobile communications device may have a processor 918 connected to the display for processing user inputs and displaying information on the display 920. A memory 902 may be connected to the processor 918 for storing any suitable information and/or applications associated with the mobile communications device 900 such as phone book entries, calendar entries, the media menu 125 described herein, etc.

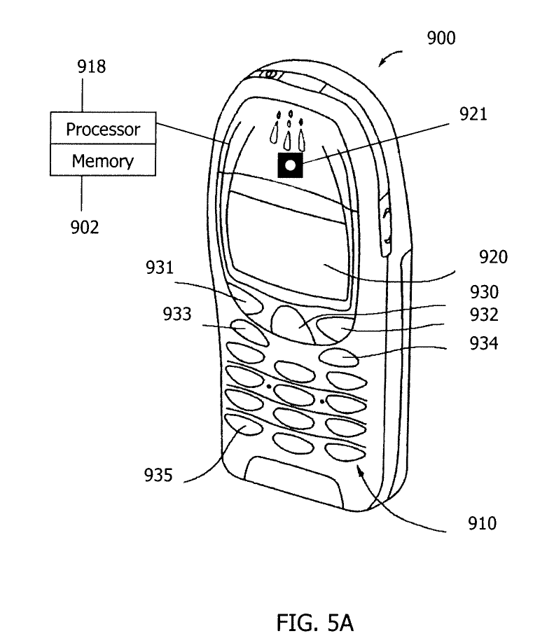

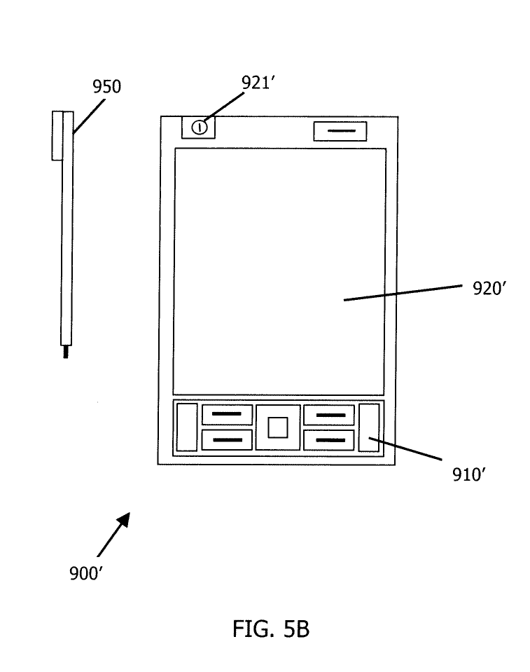

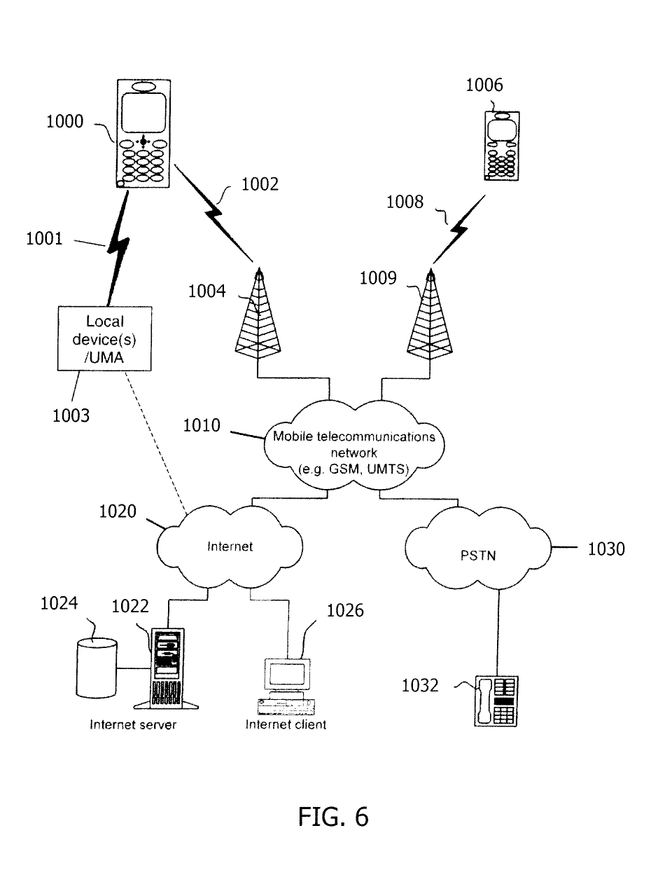

In the embodiment where the device 900 comprises a mobile communications device, the device can be adapted for communication in a telecommunication system, such as that shown in FIG. 6. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between the mobile terminal 1000 and other devices, such as another mobile terminal 1006, a line telephone 1032, a personal computer 1051 and/or an internet server 122. It is to be noted that for different embodiments of the mobile terminal 1000 and in different situations, some of the telecommunications services indicated above may or may not be available. The aspects of the disclosed embodiments are not limited to any particular set of services in this respect.

The mobile terminals 1000, 1006 may be connected to a mobile telecommunications network 1010 through radio frequency (RF) links 1002, 1008 via base stations 1004, 1009. The mobile telecommunications network 1010 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 1010 may be operatively connected to a wide area network 1020, which may be the Internet or a part thereof. An Internet server 1022 has data storage 1024 and is connected to the wide area network 1020, as is an Internet client computer 1026. The server 1022 may host a worldwide web/wireless application protocol server capable of serving worldwide web/wireless application protocol content to the mobile terminal 1000.

A public switched telephone network (PSTN) 1030 may be connected to the mobile telecommunications network 1010 in a familiar manner. Various telephone terminals, including the stationary telephone 1032, may be connected to the public switched telephone network 1030.

The mobile terminal 1000 is also capable of communicating locally via a local link 1001 or 1051 to one or more local devices 1003 or 1050. The local links 1001 or 1051 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 1003 can, for example, be various sensors that can communicate measurement values to the mobile terminal 1000 over the local link 1001. The above examples are not intended to be limiting, and any suitable type of link may be utilized. The local devices 1003 may be antennas and supporting equipment forming a wireless local area network implementing Worldwide Interoperability for Microwave Access (WIMAX, IEEE 802.16), WiFi (IEEE 802.11x) or other communication protocols. The wireless local area network may be connected to the Internet. The mobile terminal 1000 may thus have multi-radio capability for connecting wirelessly using mobile communications network 1010, wireless local area network or both. Communication with the mobile telecommunications network 1010 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 can include a communications module that is configured to interact with the system described with respect to FIG. 6.

Although the above embodiments are described as being implemented on and with a mobile communication device, it will be understood that the disclosed embodiments can be practiced on any suitable device incorporating a display, processor, memory and supporting software or hardware. In one embodiment, the system 100 of FIG. 1 may be for example, a personal digital assistant (PDA) style device 900′ illustrated in FIG. 5B. The personal digital assistant 900′ may have a keypad 910′, a touch screen display 920′, camera 921′ and a pointing device 950 for use on the touch screen display 920′. In still other alternate embodiments, the device may be a personal computer, a tablet computer, touch pad device, Internet tablet, any internet ready or capable devices, a laptop or desktop computer, a mobile terminal, a cellular/mobile phone, a multimedia device, a personal communicator, a television or television set top box, a digital video/versatile disk (DVD) or High Definition player or any other suitable device capable of containing for example a display 114 shown in FIG. 1, and supported electronics such as the processor 918 and memory 902 of FIG. 5A.

The user interface 102 of FIG. 1 can also include menu systems 124 in the navigation module 122. The navigation module 122 provides for the control of certain processes of the system 100 including, but not limited to the navigation controls for acquiring images, marking images for upload and transferring the marked images. The menu system 124 can provide for the selection of different tools and application options related to the applications or programs running on the system 100. In one embodiment, the menu system 124 may provide for the selection of the Send menu 2A101 of FIG. 1 or the features associated with the image menu A201 of FIG. 2A2. The system 124 can also provide for the navigation of the various menus and settings illustrated with respect to FIGS. 3B1-3B14 and 4C1-4C26. In the embodiments disclosed herein, the navigation module 122 receives certain inputs, such as for example, signals, transmissions, instructions or commands related to the functions of the system 100, such as marking information and upload lists. Depending on the inputs, the navigation module interprets the commands and directs the process control 132 to execute the commands accordingly.

Referring again to FIG. 1, the display 114 of the system 100 can comprise any suitable display, such as noted earlier, a touch screen display, proximity screen device or graphical user interface. In one embodiment, the display 114 can be integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of an liquid crystal display (LCD) with optional back lighting, such as a thin film transistor (TFT) matrix capable of displaying color images. A touch screen may be used instead of a conventional liquid crystal display.

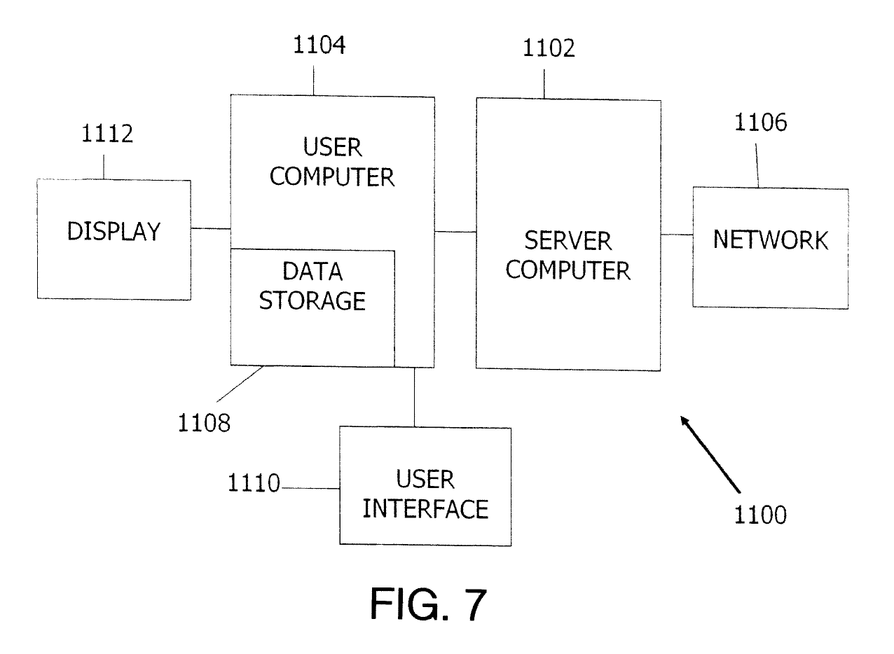

The disclosed embodiments may also include software and computer programs incorporating the process steps and instructions described above that are executed in different computers. FIG. 7 is a block diagram of one embodiment of a typical apparatus 1100 incorporating features that may be used to practice aspects of the invention. The apparatus 1100 can include computer readable program code means for carrying out and executing the process steps described herein. As shown, a computer system 1102 may be linked to another computer system 1104, such that the computers 1102 and 1104 are capable of sending information to each other and receiving information from each other. In one embodiment, computer system 1102 could include a server computer adapted to communicate with a network 1106. Computer systems 1102 and 1104 can be linked together in any conventional manner including, for example, a modem, wireless, hard wire connection, or fiber optic link. Generally, information can be made available to both computer systems 1102 and 1104 using a communication protocol typically sent over a communication channel or through a dial-up connection on an integrated services digital network (ISDN) line. Computers 1102 and 1104 are generally adapted to utilize program storage devices embodying machine-readable program source code, which is adapted to cause the computers 1102 and 1104 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1102 and 1104 may also include a microprocessor for executing stored programs. Computer 1102 may include a data storage device 1108 on its program storage device for the storage of information and data. The computer program or software incorporating the processes and method steps incorporating aspects of the invention may be stored in one or more computers 1102 and 1104 on an otherwise conventional program storage device. In one embodiment, computers 1102 and 1104 may include a user interface 1110, and a display interface 1112 from which aspects of the invention can be accessed. The user interface 1110 and the display interface 1112 can be adapted to allow the input of queries and commands to the system, as well as present the results of the commands and queries.

The embodiments described herein provide a user with a quick and easy way to transfer images from a device to an imaging service. The user is able to capture an image and transfer or upload the image to an on-line service by simply activating a single button or function on the device. The configuration of the upload service can be pre-stored on the device or alternatively on a server, including for example, the username, password, and other specifications and requirements. When the image is captured, or picture taken, the transfer or upload can be automatic or require user intervention, and can also depend on network coverage or other user defined pre-requisites. There is no need to store any image in the device itself, prior to uploading it to the service. Different image and content types can easily be accommodated by associating content types with particular services or uploading the content to an intermediary where content type is configured for a particular service or compatible content providers are selected.

It is noted that the aspects of the embodiments described herein can be used individually or in any combination thereof. It should be understood that the foregoing description is only illustrative of the embodiments. Various alternatives and modifications can be devised by those skilled in the art without departing from the scope of the disclosed embodiments. Accordingly, the present embodiments are intended to embrace all such alternatives, modifications and variances that fall within the scope of the appended claims.

1. A method comprising:
accessing at least one content item stored in a device;
selecting a remote server to which to transfer the at least one content item; and
transferring the at least one content item to the remote server.

2. The method of claim 1 wherein the at least one content item comprises an image, audio or video file.

3. The method of claim 2 where the at least one content item comprises a multi-media file.

4. The method of claim 1 further comprising automatically logging into a user account on the remote server to transfer the at least one content item to the user account on the remote server.

5. The method of claim 4 wherein user account settings are stored in the device to enable the automatic login to the user account.

6. The method of claim 1 wherein the device is a mobile communication device and the remote server is an image processing, storing and sharing facility.

7. The method of claim 1 wherein accessing at least one content item comprises capturing at least one image with the device.

8. The method of claim 1 wherein accessing at least one content item comprises marking at least one image file stored in a memory of the device.

9. The method of claim 1 wherein accessing at least one content component comprises accessing an image file and selecting a remote server further comprises:
selecting a image transfer option from a transfer menu of the device;
automatically accessing a remote server corresponding to the selected image transfer option; and
transferring the image to the remote server.

10. The method of claim 9 wherein the image transfer options include web services uploads.

11. The method of claim 9 wherein the image transfer options include mobile information device profile applications.

12. The method of claim 9 wherein selecting an image transfer option further comprises:
presenting one or more image transfer options on an image option transfer menu of the device;
identifying a file type of the image selected to be transferred; and
automatically selecting only those image transfer options on the image option transfer menu that do not support the file type of the image selected to be transferred.

13. The method of claim 1 wherein the content item is a multimedia image file.

14. The method of claim 1 further comprising:
capturing at least one image in the device and storing the at least one captured image as the at least one content item;
marking the at least one content item as an upload candidate;
detecting that the device is connected to a network; and
transferring each marked content item to the remote server.

15. The method of claim 14 wherein the remote server is a web-based image upload service.

16. The method of claim 14 further comprising automatically transferring each marked content item upon detection of a network connection by the device.

17. The method of claim 14 further comprising, after the device detects the network connection:
determining if there is at least one upload candidate;
prompting the user to initiate the transfer of the at least one upload candidate to the remote server; and
transferring the at least one upload candidate to the remote server when the user initiates the transfer.

18. The method of claim 1 wherein accessing the at least one content item comprises searching one or more storage facilities associated with the device for all files marked as upload files, determining if a file type of each marked filed is supported by the selected remote server, and transferring only supported files to the remote server.

19. The method of claim 1 further comprising launching a browser of the remote server and initiating an upload of the at least one content item to the remote server from the browser.

20. The method of claim 1 wherein accessing comprises detecting all files stored in a storage facility associated with the device that are marked for upload; creating an upload file list; and adding newly marked files to the list during an ongoing upload session.

21. A method comprising:
marking at least one content file stored in a device as an upload candidate;
detecting a network connection between the device and a network;
establishing a communication link between the device and a content upload service; and
transferring each content file marked as an upload candidate to the content upload service.

22. The method of claim 21 wherein the at least one content file comprises an image, audio or video file.

23. The method of claim 21 where the at least one content file comprises a multi-media file.

24. The method of claim 21 further comprising capturing a content file in the device and automatically marking each captured content file as an upload candidate.

25. The method of claim 24 further comprising automatically transferring each upload candidate to the content upload service upon establishment of the network connection.

26. The method of claim 21 further comprising providing a user with a prompt prior to transferring each upload candidate and only transferring each upload candidate when a positive response is received from the user.

27. The method of claim 21 further comprising:
capturing an image in the device using an image capture device;
storing the captured image in a temporary storage facility; and
marking each stored image as an upload candidate.

28. The method of claim 27 further comprising the temporary storage facility being remote from the device.

29. The method of claim 27 further comprising each marked image being transferred from the remote storage facility to the image upload service when the network connection is established.

30. The method of claim 21 further comprising detecting that a storage facility for the device is substantially at capacity, automatically establishing a communication link with the network to transfer all upload candidates, and creating empty storage in the storage facility.

31. The method of claim 21 further comprising:
detecting an interruption in the network connection during the upload process;
determining which marked files were uploaded and which mark files were not uploaded;
detecting that the network connection is re-established; and
resuming the file upload.

32. The method of claim 31 wherein the resumed file upload includes any new files marked for upload since an initial upload process.

33. A method comprising:
capturing at least one image with a camera of a mobile communication device;
presenting a user with a send option on the mobile communication device; and
activating the send option to automatically transfer the at least one captured image to a remote image processing service provider.

34. The method of claim 33 wherein activating the send option further comprises launching a web browser program for the remote image processing service provider; logging into a user account with the service provider; and transferring the at least one captured image to the user account upon a successful login.

35. The method of claim 33 further comprising deleting the at least one captured image from the mobile communications device after a successful transfer of the at least one captured image.

36. The method of claim 33 further comprising not storing the captured image on the device if the send option is selected.

37. The method of claim 33 wherein the remote image processing service center is automatically selected based on a file type of the captured image and a corresponding user account.

38. The method of claim 33 wherein presenting the send option also comprises providing a uniform resource locator for the remote image processing service center.

39. The method of claim 33 further comprising capturing more than one image, storing each image file in a list, and transferring each image file to the remote center when the send option is selected.

40. A computer program product embodied in a memory of a device comprising:
computer readable program code embodied in a computer readable medium for executing the method of claim 1.

41. The computer program product of claim 40, further comprising computer readable program code embodied in a computer readable medium for:
capturing at least one image in the device as the at least one content item;
marking the at least one content item as an upload candidate;
detecting that the device is connected to a network; and
automatically transferring each marked content item to the remote server.

42. An apparatus comprising:
at least one processor;
wherein the at least one processor is configured to:
capture at least one image;
mark the at least one image as an upload candidate;
detect a network connection;
establish a communication link between the apparatus and a user account at a remote server; and
transfer the at least one marked image to the user account at the remote server.

43. The apparatus of claim 2, wherein the processor is further configured to provide a notification to the user that there is at least one image to be transferred, and transfer the at least one image to the remote server upon receipt of a positive notification from the user.
